(19) United States
(12) Patent Application Publication
(10) Pub. No.: US 2026/0160977 A1
(43) Pub. Date: Jun. 11, 2026

(54) OPTICAL IMAGING LENS ASSEMBLY

(71) Applicant: ZHEJIANG SUNNY OPTICS CO., LTD., Zhejiang (CN)

(72) Inventors: XINGXING XUE, Zhejiang (CN); XIAOFENG WENG, Zhejiang (CN); LITONG SONG, Zhejiang (CN); YINFANG JIN, Zhejiang (CN); LIEFENG ZHAO, Zhejiang (CN)

(21) Appl. No.: 19/242,001

(22) Filed: Jun. 18, 2025

(30) Foreign Application Priority Data
Dec. 10, 2024 (CN) 202411813795.8

(51) Int. Cl. G02B 13/00

(52) U.S. Cl. CPC G02B 13/004

(57) ABSTRACT

An optical imaging lens assembly includes a lens assembly, a spacing element assembly, and a lens barrel. The lens assembly includes a first lens to a fourth lens; the lens assembly and the spacing element assembly are accommodated in the lens barrel; an effective focal length f4 of the fourth lens and an on-axis distance T34 between an image-side surface of the third lens and an object-side surface of the fourth lens meet: −231.04≤f4/T34≤−105.74; and the effective focal length f4 of the fourth lens, a center thickness CT4 of the fourth lens, and a maximum thickness CP3 of a third spacing element along the optical axis meet:

$$- 6.58 \leq f 4 / ( CP 3 + CT 4 ) \leq - 4.35 .$$

### CROSS-REFERENCE TO RELATED APPLICATION AND CLAIM OF PRIORITY

This disclosure claims priority to Chinese Patent Application No. 202411813795.8 filed on Dec. 10, 2024, the entire contents of each of which are incorporated herein by reference for all purposes. No new matter has been introduced.

### BACKGROUND

### 1. Technical Field

The disclosure relates to the technical field of optical imaging devices, and specifically, to an optical imaging lens assembly.

### 2. Background Art

An environment sensing module plays a crucial role in autonomous driving technology. Lidar, as a main environment sensing solution, shows great advantages and broad application prospects in the field of autonomous driving by virtue of its full-time working capability, low sensitivity to ambient light, and high ranging accuracy. In an automated driving environment, optical imaging lens assemblies need to maintain stable operating performance under a variety of harsh conditions, such that the assembly stability of the optical imaging lens assemblies must be taken into consideration during design. Lidar typically uses light in a near-infrared band for detection, such that the optical imaging lens assembly at a receiving end must be able to operate in the near-infrared band to ensure that a received signal has sufficient strength and clarity. In the design of a conventional four-piece optical imaging lens assembly, a rear end lens has a large impact on the final imaging effect, and is prone to extreme design of lens shapes, with large differences in the center and edge thicknesses of the lens, thus affecting the assembly stability. However, influenced by mutual constraints of a structural design among a plurality of lenses, and when a shape of a third lens is rational, a structure of a fourth lens is difficult to meet requirements for compression molding, and the assembly stability is also relatively poor. That is to say, how to control a shape of the fourth lens while ensuring the molding and assembly of the third lens, taking into account the molding and assembly stability of two rear-end lenses is a very important issue.

### SUMMARY

Some embodiments of the disclosure is to provide an optical imaging lens assembly, so as to solve the problem of how to take into account the molding and assembly stability of two lenses at a rear end of an optical imaging lens assembly in the related art.

In an embodiment of the disclosure, an optical imaging lens assembly is provided. The optical imaging lens assembly has four lenses having refractive powers. The optical imaging lens assembly includes: a lens assembly, including, from an object side to an image side of the optical imaging lens assembly, a first lens to a fourth lens, which are sequentially arranged at intervals; a spacing element assembly, including at least a first spacing element that is located between the first lens and a second lens and is in at least partial contact with an image-side surface of the first lens, a second spacing element that is located between the second lens and a third lens and is in at least partial contact with an image-side surface of the second lens, and a third spacing element that is located between the third lens and the fourth lens and is in at least partial contact with an image-side surface of the third lens; and a lens barrel, where the lens assembly and the spacing element assembly are accommodated in the lens barrel; an effective focal length f4 of the fourth lens and a distance T34 between the image-side surface of the third lens and an object-side surface of the fourth lens on the optical axis meet: −231.04≤f4/T34≤−105.74; and the effective focal length f4 of the fourth lens, a center thickness CT4 of the fourth lens, and a maximum thickness CP3 of a third spacing element along the optical axis meet: −6.58≤f4/(CP3+CT4)≤−4.35.

In another embodiment of the disclosure, an optical imaging lens assembly is provided. The optical imaging lens assembly has four lenses having refractive powers. The optical imaging lens assembly includes: a lens assembly, including, from an object side to an image side of the optical imaging lens assembly, a first lens to a fourth lens, which are sequentially arranged at intervals; a spacing element assembly, including at least a first spacing element that is located between the first lens and a second lens and is in at least partial contact with an image-side surface of the first lens, a second spacing element that is located between the second lens and a third lens and is in at least partial contact with an image-side surface of the second lens, and a third spacing element that is located between the third lens and the fourth lens and is in at least partial contact with an image-side surface of the third lens; and a lens barrel, where the lens assembly and the spacing element assembly are accommodated in the lens barrel; a maximum thickness CP1 of the first spacing element along the optical axis, a center thickness CT1 of the first lens, and a center thickness CT2 of the second lens meet: 0.89≤CP1/(CT1+CT2)≤1.34; and a curvature radius R4 of an image-side surface of the second lens and an outer diameter D1m of an image-side surface of the first spacing element meet: 3.89≤D1m/R4≤4.29. In yet another embodiment of the disclosure, an optical imaging lens assembly is provided. The optical imaging lens assembly has four lenses having refractive powers. The optical imaging lens assembly includes: a lens assembly, including, from an object side to an image side of the optical imaging lens assembly, a first lens to a fourth lens, which are sequentially arranged at intervals; a spacing element assembly, including at least a first spacing element that is located between the first lens and a second lens and is in at least partial contact with an image-side surface of the first lens, a second spacing element that is located between the second lens and a third lens and is in at least partial contact with an image-side surface of the second lens, and a third spacing element that is located between the third lens and the fourth lens and is in at least partial contact with an image-side surface of the third lens; and a lens barrel, where the lens assembly and the spacing element assembly are accommodated in the lens barrel; an effective focal length f4 of the fourth lens and a distance T34 between the image-side surface of the third lens and an object-side surface of the fourth lens on the optical axis meet: −231.04≤f4/T34≤−105.74; and a curvature radius R7 of an object-side surface of the fourth lens and an inner diameter d3m of an image-side surface of the third spacing element meet: 0.41≤R7/d3m≤0.46.

In an embodiment, a maximum thickness CP1 of the first spacing element along the optical axis, a center thickness CT1 of the first lens, and a center thickness CT2 of the second lens meet: 0.89≤CP1/(CT1+CT2)≤1.34.

In an embodiment, a distance EP01 between an object-side end surface of the lens barrel and an object-side surface of the first spacing element on the optical axis and a vector height SAG11 of an object-side surface of the first lens meet: 3.20≤EP01/|SAG11|≤3.78.

In an embodiment, the first lens is a glass aspheric lens, and an outer diameter D1s of an object-side surface of the first spacing element, a curvature radius R1 of an object-side surface of the first lens, and a refractive index N1 of the first lens meet: −1.81≤D1s/(R1*N1)≤−1.49. In an embodiment, a curvature radius R4 of the image-side surface of the second lens and an outer diameter D1m of an image-side surface of the first spacing element meet: 3.89≤D1m/R4≤4.29.

In an embodiment, an outer diameter D2m of an image-side surface of the second spacing element and a curvature radius R5 of an object-side surface of the third lens meet: 1.14≤D2m/R5≤1.53.

In an embodiment, the third lens is a glass aspheric lens, and a curvature radius R5 of an object-side surface of the third lens, a refractive index N3 of the third lens, and an inner diameter d3s of an object-side surface of the third spacing element meet: 1.19≤R5*N3/d3s≤1.48.

In an embodiment, an outer diameter D3m of an image-side surface of the third spacing element, an outer diameter D3s of an object-side surface of the third spacing element, a curvature radius R6 of the image-side surface of the third lens, and a curvature radius R7 of the object-side surface of the fourth lens meet: −1.22≤D3m/R7/(D3s/R6)≤−0.98.

In an embodiment, a maximum height L of the lens barrel and a center thickness CT3 of the third lens meet: 2.72≤L/CT3≤3.37.

In an embodiment, an outer diameter D0m of an image-side end surface of the lens barrel, an outer diameter D0s of an object-side end surface of the lens barrel, and a half of a diagonal length ImgH of an effectively pixel region on an imaging surface of the optical imaging lens assembly meet: 0.32≤(D0m−D0s)/ImgH≤1.17.

In an embodiment, an inner diameter dos of an object-side end surface of the lens barrel, an inner diameter d0m of an image-side end surface of the lens barrel, and a half of a diagonal length ImgH of an effectively pixel region on an imaging surface of the optical imaging lens assembly meet: 1.01≤(d0m−d0s)/ImgH≤1.30.

In an embodiment, the third lens has a positive refractive power, and the fourth lens has a negative refractive power.

In an embodiment, the object-side surface of the first lens is a concave surface, the image-side surface of the first lens is a convex surface, an object-side surface of the second lens is a convex surface, the image-side surface of the second lens is a concave surface, the object-side surface of the third lens is a convex surface, the image-side surface of the third lens is a convex surface, the object-side surface of the fourth lens is a convex surface, and an image-side surface of the fourth lens is a concave surface.

By using the technical solutions of the disclosure, the optical imaging lens assembly has four lenses having refractive powers. The optical imaging lens assembly includes the lens assembly, the spacing element assembly, and the lens barrel. The lens assembly, from the object side to the image side of the optical imaging lens assembly, includes the first lens to the fourth lens, which are sequentially arranged at intervals; the spacing element assembly includes at least the first spacing element that is located between the first lens and the second lens and is in at least partial contact with the image-side surface of the first lens, the second spacing element that is located between the second lens and the third lens and is in at least partial contact with the image-side surface of the second lens, and the third spacing element that is located between the third lens and the fourth lens and is in at least partial contact with the image-side surface of the third lens; and the lens assembly and the spacing element assembly are accommodated in the lens barrel. The effective focal length f4 of the fourth lens and the on-axis distance T34 between the image-side surface of the third lens and the object-side surface of the fourth lens meet: −231.04≤f4/T34≤−105.74; and the effective focal length f4 of the fourth lens, the center thickness CT4 of the fourth lens, and the maximum thickness CP3 of a third spacing element along the optical axis meet: −6.58≤f4/(CP3+CT4)≤−4.35.

The optical imaging lens assembly of the disclosure uses four lenses having refractive powers, and the first lens to the fourth lens are sequentially arranged at intervals. In order to meet the assembly stability of the optical imaging lens assembly, by controlling the f4/T34 within a rational range, the curvature radius of the image-side surface of the third lens is maintained at a large degree, such that an edge thickness of the third lens is maintained within an appropriate range, thereby improving the stability and reliability of compression molding of the third lens, and finally improving the assembly stability of the third lens. However, in this case, the curvature radius of the object-side surface of the fourth lens becomes larger, causing the fourth lens to show a phenomenon of being thick in center and thin in edge within an effective diameter range, thus resulting in the problem of unstable assembly of the fourth lens. Therefore, by controlling the f4/(CP3+CT4) within a rational range, the focal length and center thickness of the fourth lens are further limited, such that the situation that the assembly stability of the fourth lens is reduced due to the improvement of the assembly stability of the third lens is avoided. The disclosure maintains the stability and good optical performance of the fourth lens of the optical imaging lens assembly while ensuring the improvement of the reliability of the third lens.

### BRIEF DESCRIPTION OF THE DRAWINGS

The drawings, which form a part of the disclosure, are used to provide a further understanding of the disclosure. The exemplary embodiments of the disclosure and the description thereof are used to explain the disclosure, but do not constitute improper limitations to the disclosure. In the drawings:

FIG. 1 is a schematic diagram of partial parameters of an optical imaging lens assembly according to any one of optional embodiments of the disclosure.

FIG. 2 is a schematic structural diagram of an optical imaging lens assembly according to Embodiment I of the disclosure.

FIGS. 3 to 6 respectively show a longitudinal aberration curve, astigmatism curve, distortion curve, and lateral color curve of the optical imaging lens assembly according to Embodiment I of the disclosure.

FIG. 7 is a schematic structural diagram of an optical imaging lens assembly according to Embodiment II of the disclosure.

FIG. 8 is a schematic structural diagram of an optical imaging lens assembly according to Embodiment III of the disclosure.

FIGS. 9 to 12 respectively show a longitudinal aberration curve, astigmatism curve, distortion curve, and lateral color curve of the optical imaging lens assembly according to Embodiment III of the disclosure.

FIG. 13 is a schematic structural diagram of an optical imaging lens assembly according to Embodiment IV of the disclosure.

FIG. 14 is a schematic structural diagram of an optical imaging lens assembly according to Embodiment V of the disclosure.

FIGS. 15 to 18 respectively show a longitudinal aberration curve, astigmatism curve, distortion curve, and lateral color curve of the optical imaging lens assembly according to Embodiment V of the disclosure.

FIG. 19 is a schematic structural diagram of an optical imaging lens assembly according to Embodiment VI of the disclosure.

FIG. 20 is a schematic structural diagram of an optical imaging lens assembly according to Embodiment VII of the disclosure.

FIGS. 21 to 24 respectively show a longitudinal aberration curve, astigmatism curve, distortion curve, and lateral color curve of the optical imaging lens assembly according to Embodiment VII of the disclosure.

FIG. 25 is a schematic structural diagram of an optical imaging lens assembly according to Embodiment VIII of the disclosure.

FIG. 26 shows a tolerance analysis result of an optical imaging lens assembly under conditions of f4/T34=−105.74 and f4/(CP3+CT4)=−4.35 according to the disclosure.

FIG. 27 shows a tolerance analysis result of an optical imaging lens assembly under conditions of f4/T34=−105.74 and f4/(CP3+CT4)=−1.25 in the related art.

FIG. 28 shows a tolerance analysis result of an optical imaging lens assembly under conditions of f4/T34=−105.74 and f4/(CP3+CT4)=−10.37 in the related art.

The above drawings include the following reference numerals:
P0. Lens barrel; E1. First lens; P1. First spacing element; E2. Second lens; P2. Second spacing element; E3. Third lens; P3. Third spacing element; E4. Fourth lens; P4. Fourth spacing element; S1. Object-side surface of first lens; S2. Image-side surface of first lens; S3. Object-side surface of second lens; S4. Image-side surface of second lens; S5. Object-side surface of third lens; S6. Image-side surface of third lens; S7. Object-side surface of fourth lens; and S8. Image-side surface of fourth lens.

### DETAILED DESCRIPTION OF THE EMBODIMENTS

It is to be noted that the embodiments in the disclosure and the features in the embodiments may be combined with one another without conflict. The disclosure will be described below in detail with reference to the drawings and the embodiments.

It is to be noted that, unless otherwise defined, all technical and scientific terms used herein have the same meaning as commonly understood by those of ordinary skill in the art to which the disclosure belongs.

In the disclosure, in the absence of any indication to the contrary, terms such as “on, under, top, and bottom” are used generally with respect to the orientation shown in the drawings, or with respect to the parts themselves in the vertical, perpendicular, or gravitational direction; and similarly, for ease of comprehension and description, “inside or outside” refers to the inside and the outside of the contours of the respective parts themselves, provided, however, that the above terms are not intended to be used in a manner that restricts the disclosure.

It is to be noted that, in the specification, expressions such as first, second, third, etc. are used only to distinguish one feature from another and do not indicate any limitation of the features. Accordingly, without departing from the teachings of the disclosure, the first lens discussed below may also be referred to as a second lens or a third lens.

In the drawings, the thickness, size and shape of the lens have been slightly exaggerated for ease of illustration. Specifically, a spherical shape or aspheric shape shown in the drawings is shown by some embodiments. That is, the spherical shape or the aspheric shape is not limited to the spherical shape or aspheric shape shown in the drawings. The drawings are for illustrative purposes only and are not strictly to scale.

Herein, a paraxial region refers to a region nearby an optical axis. If the surface of a lens is convex and a position of the convex surface is not defined, it indicates that the lens surface is a convex surface at least in the paraxial region; and if the surface of the lens is a concave surface and a position of the concave surface is not defined, it indicates that the lens surface is a concave surface at least in the paraxial region. Determination of the shape of the surface in the paraxial region may be based on the determination of those who are generally knowledgeable in the art, a convex surface and a concave surface are determined by a positive R-value or a negative R-value (R refers to a curvature radius of the paraxial region, and generally refers to an R value on a lens data base in optical software). For an eye side surface, when the R value is positive, the convex surface is determined; and when the R value is negative, the concave surface is determined. For a display side surface, when the R value is positive, the concave surface is determined; and when the R value is negative, the convex surface is determined.

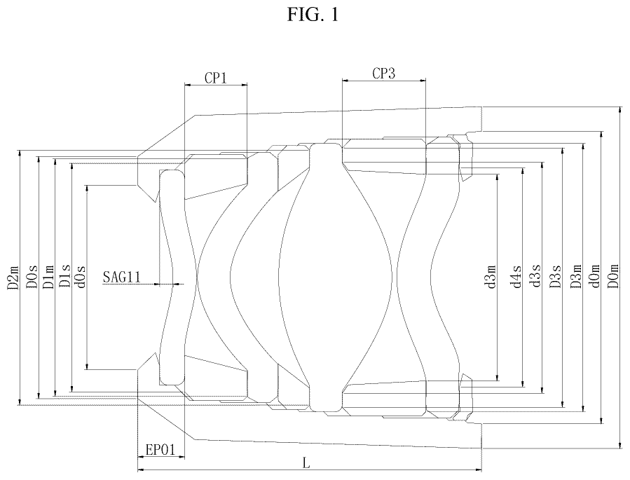

As shown in FIGS. 1 to 26, an optical imaging lens assembly has four lenses having refractive powers. The optical imaging lens assembly includes a lens assembly, a spacing element assembly, and a lens barrel. The lens assembly, from an object side to an image side of the optical imaging lens assembly, includes a first lens to a fourth lens, which are sequentially arranged at intervals; the spacing element assembly includes at least a first spacing element that is located between the first lens and a second lens and is in at least partial contact with an image-side surface of the first lens, a second spacing element that is located between the second lens and a third lens and is in at least partial contact with an image-side surface of the second lens, and a third spacing element that is located between the third lens and the fourth lens and is in at least partial contact with an image-side surface of the third lens; and the lens assembly and the spacing element assembly are accommodated in the lens barrel; an effective focal length f4 of the fourth lens and a distance T34 between the image-side surface of the third lens and an object-side surface of the fourth lens on the optical axis meet: −231.04≤f4/T34≤−105.74; and the effective focal length f4 of the fourth lens, a center thickness CT4 of the fourth lens, and a maximum thickness CP3 of a third spacing element along the optical axis meet: −6.58≤f4/(CP3+CT4)≤−4.35.

The optical imaging lens assembly of the disclosure uses four lenses having refractive powers, and the first lens to the fourth lens are sequentially arranged at intervals. In order to meet the assembly stability of the optical imaging lens assembly, by controlling the f4/T34 within a rational range, the curvature radius of the image-side surface of the third lens is maintained at a large degree, such that an edge thickness of the third lens is maintained within an appropriate range, thereby improving the stability and reliability of compression molding of the third lens, and finally improving the assembly stability of the third lens. However, in this case, the curvature radius of the object-side surface of the fourth lens becomes larger, causing the fourth lens to show a phenomenon of being thick in center and thin in edge within an effective diameter range, thus resulting in the problem of unstable assembly of the fourth lens. Therefore, by controlling the f4/(CP3+CT4) within a rational range, the focal length and center thickness of the fourth lens are further limited, such that the situation that the assembly stability of the fourth lens is reduced due to the improvement of the assembly stability of the third lens is avoided. The disclosure maintains the stability and good optical performance of the fourth lens of the optical imaging lens assembly while ensuring the improvement of the reliability of the third lens.

Table 1 below shows comparison of tolerance analysis results of optical imaging lens assemblies in an optional embodiment of the disclosure and in the related art.

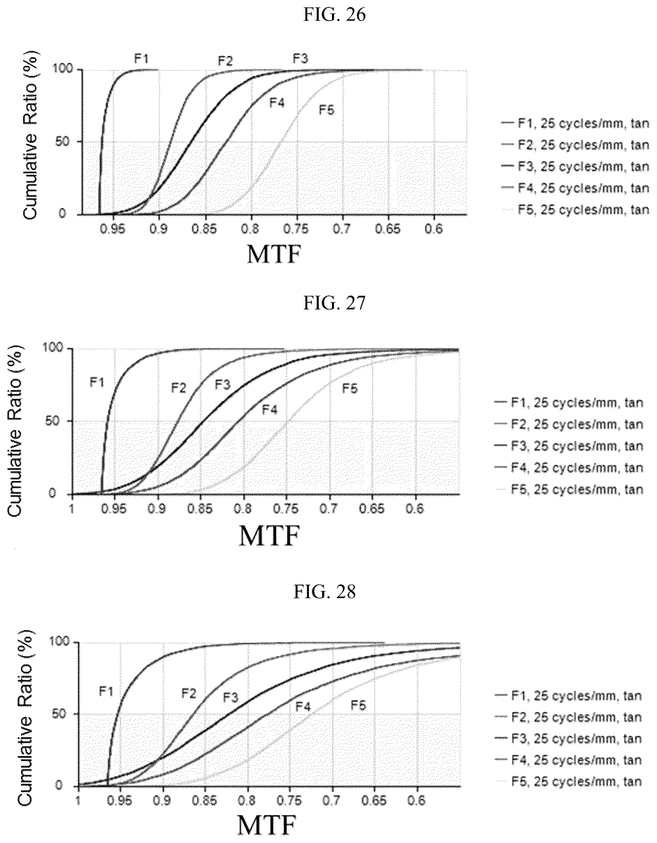

TABLE 1

| | Lens 1 | Lens 2 | Lens 3 |
|---|---|---|---|
| Conditional | f4/T34 = −105.74; | f4/T34 = −105.74; | f4/T34 = −105.74; |
| expression | f4/(CP3 + CT4) = −4.35 | f4/(CP3 + CT4) = −1.25 | f4/(CP3 + CT4) = −10.37 |
| Drawings | FIG. 26 | FIG. 27 | FIG. 28 |

Lens 2 and Lens 3 in Table 1 are optical imaging lens assemblies in the related art. A horizontal coordinate Modulation Transfer Function (MTF) of the tolerance analysis result represents an MTF value, and a vertical coordinate simulates a cumulative ratio; and if the cumulative ratio at a corresponding same MTF value is higher, it indicates that a performance yield of the optical imaging lens assembly at the MTF value is higher. The Lens 2 is shown in FIG. 27. Under a condition of f4/(CP3+CT4)=−1.25, the curvature radius of the object-side surface of the fourth lens is increased abnormally, causing the fourth lens to be thick in center and thin in edge, which not only affects the structural stability of the fourth lens, but also increases the difficulty of compression molding, leading to a large assembly tolerance and low yield of the optical imaging lens assembly. The Lens 3 is shown in FIG. 28. Under a condition of f4/(CP3+CT4)=−10.37, the object-side surface of the fourth lens needs a larger curvature radius or a thicker shape, causing the thickness of the edge region of the object-side surface of the fourth lens to be relatively thinned, thus increasing the difficulty and instability risks of compression molding, and leading to the large assembly tolerance and low yield of the optical imaging lens assembly.

For the optical imaging lens assembly of the disclosure, by controlling a f4/T34 ratio within a rational range, as shown in FIG. 26, the curvature radius of the image-side surface of the third lens is larger, the edge thickness of the third lens confirms to stability and reliability requirements thereof for compression molding, the assembly of the third lens is stable, and finally, the assembly tolerance of the optical imaging lens assembly is small, and the yield is high.

In this implementation, a maximum thickness CP1 of the first spacing element along the optical axis, a center thickness CT1 of the first lens, and a center thickness CT2 of the second lens meet: 0.89≤CP1/(CT1+CT2)≤1.34. Since CP1 may be regarded as a sum of a vector height of the image-side surface of the first lens, an air gap between the first lens and the second lens, and a vector height of the object-side surface of the second lens, the controlling of an amplitude of the CP1 also reflects a vector height situation of the first lens and the second lens. The vector height describes a degree of deviation of the lens surface relative to its central axis and is critical to the optical performance of the lens. When a ratio of CP1/(CT1+CT2) is less than 0.89, the vector height of the image-side surface of the first lens and the vector height of the object-side surface of the second lens become smaller, a refractive power to lights becomes weaker, such that the third lens needs to be thickened for compensation, leading to an increase in the thickness of the third lens, and thus affecting the compression molding of the third lens. When the ratio of CP1/(CT1+CT2) is greater than 1.34, the vector height of the image-side surface of the first lens and the vector height of the object-side surface of the second lens are too large, leading to a poor surface type and an excessive wavefront aberration of the molding of the second lens, thus affecting a final imaging effect of the optical imaging lens assembly. By controlling the CP1/(CT1+CT2) within a rational range, the vector height of the image-side surface of the first lens, the vector height of the object-side surface of the second lens, and the air gap between the first lens and the second lens are able to be maintained within the rational range, the lenses have good molding effects, improvement of the stability of the optical imaging lens assembly during assembly is facilitated, and an assembly tolerance caused by non-matching shapes of the lenses is reduced.

It is to be noted that, the vector height of the lens surface indicates an on-axis distance between an intersection point of the lens surface and an optical axis and a vertex of the effective radius. In this implementation, a distance EP01 between an object-side end surface of the lens barrel and an object-side surface of the first spacing element on the optical axis and a vector height SAG11 of an object-side surface of the first lens meet: 3.20≤EP01/|SAG11|≤3.78. The EP01 may be regarded as a sum of the object-side end surface of the lens barrel and the edge thickness of the first lens, and the |SAG11| is a length of the vector height of the object-side surface of the first lens. When a ratio of EP01/|SAG11| is less than 3.20, the edge thickness of the first lens is small, and the vector height of the object-side surface of the first lens is large, leading to risks of poor compression molding of the first lens. When the ratio of EP01/|SAG11| is greater than 3.78, the vector height of the object-side surface of the first lens is small while the edge thickness is large, and there is a phenomenon of edge inflection in the effective diameter of the first lens, such that the compression molding of the first lens is difficult to ensure. By controlling EP01/|SAG11| within a rational range, the vector height of the object-side surface of the first lens is controlled, such that phenomena such as edge inflection and the like are not easy to occur during compression molding, thereby ensuring the stability and quality of the molding of the first lens. Moreover, the rational control of EP01/|SAG11| facilitates the reduction in the tolerance when the optical imaging lens assembly is assembled, so as to cause the first lens to be more stable during assembly, thereby reducing optical performance degradation caused by assembly errors. Furthermore, a relative position of the vector height of the object-side surface of the first lens and the object-side end surface of the lens barrel is properly controlled, such that the first lens may be guaranteed to be fixed in a correct position, thereby reducing unnecessary stress and deformation.

In this implementation, the first lens is a glass aspheric lens, and an outer diameter D1s of an object-side surface of the first spacing element, a curvature radius R1 of an object-side surface of the first lens, and a refractive index N1 of the first lens meet: −1.81≤D1s/(R1*N1)≤−1.49. Since the first lens of the optical imaging lens assembly uses an aspheric glass material, and an aspheric curve of the image-side surface of the first lens is prone to inflection, the compression molding of the first lens is affected when an inflection degree is too large. When a ratio of D1s/(R1*N1) is too small or too large, the edge of the effective diameter of the image-side surface of the first lens is severely inflected, causing the molding to be more difficult. By controlling D1s/(R1*N1) within a rational range, the shape of the first lens is able to be controlled to meet the requirement for compression molding, so as to reduce the inflection phenomenon at the edge, thereby reducing a failure rate of the first lens during manufacturing, and increasing a production yield of the optical imaging lens assembly. Furthermore, by controlling the ratio of D1s/(R1*N1) within a rational range, the structural strength and optical performance of the first lens are balanced, thereby ensuring that the optical performance of the first lens is not affected when structure design conditions are met.

In this implementation, a curvature radius R4 of an image-side surface of the second lens and an outer diameter D1m of an image-side surface of the first spacing element meet: 3.89≤D1m/R4≤4.29. When D1m/R4 is too small, a vector height of the image-side surface of the second lens is too large, affecting the molding of the second lens. When D1m/R4 is too large, the refractive capability of the second lens is reduced. As compensation, the thickness of the third lens becomes larger, and an aspheric curve thereof is flattened, leading to poor molding of the third lens. By controlling D1m/R4 within a rational range, it may ensure that the image-side surface of the second lens has an appropriate curvature radius to maintain good refractive capability, and a too large refraction angle of a light caused by a too small curvature radius of the image-side surface of the second lens is avoided at the same time, thereby reducing an aberration, and optimizing the imaging performance of the optical imaging lens assembly. Furthermore, D1m/R4 being within the rational range may ensure the smooth transition of the light transferred from the first lens to the second lens, and a segment difference and an assembly tolerance are reduced, thereby improving the stability and reliability of the optical imaging lens assembly.

In this embodiment, an outer diameter D2m of an image-side surface of the second spacing element and a curvature radius R5 of an object-side surface of the third lens meet: 1.14≤D2m/R5≤1.53. When a ratio of D2m/R5 is too small, a contact area of the third lens and the second spacing element is insufficient, there are risks when the optical imaging lens assembly is assembled. When the ratio of D2m/R5 is too large, a segment difference between the second spacing element and the third lens is enlarged, causing the outer diameter of the third lens to be further expanded, and the size of the optical imaging lens assembly to become larger. Furthermore, since a segment difference between the second spacing element and the third spacing element is increased, a material of the second spacing element changes from plastic to metal, leading to an increase in the cost of the optical imaging lens assembly. By controlling D2m/R5 within a rational range, it may ensure that there is a sufficient contact area between the second spacing element and the third lens, such that sufficient support and positioning are provided during assembly, and displacement or instability of the third lens due to insufficient contact is prevented, thereby ensuring the assembly accuracy and stability of the optical imaging lens assembly, and balancing the cost and imaging quality of the optical imaging lens assembly.

In this embodiment, the third lens is a glass aspheric lens, and a curvature radius R5 of an object-side surface of the third lens, a refractive index N3 of the third lens, and an inner diameter d3s of an object-side surface of the third spacing element meet: 1.19≤R5*N3/d3s≤1.48. When the third lens uses the glass material, the light is easily reflected to form stray light at the third spacing element. When a ratio of R5*N3/d3s is too small, a contact area between the third spacing element and the third lens is insufficient, resulting in risks of unstable assembly. When the ratio of R5*N3/d3s is too large, the object-side inner diameter of the third spacing element is too small, and the light is reflected on an inner diameter surface of the third spacing element, leading to a reduction in the imaging quality of the optical imaging lens assembly. By controlling R5*N3/d3s within a rational range, the generation of the stray light may be effectively avoided at an inner diameter sharp corner of the third spacing element, and unexpected light spots and interference are reduced, thereby improving the imaging quality of the optical imaging lens assembly.

In this implementation, an outer diameter D3m of an image-side surface of the third spacing element, an outer diameter D3s of an object-side surface of the third spacing element, a curvature radius R6 of an image-side surface of the third lens, and a curvature radius R7 of an object-side surface of the fourth lens meet: −1.22≤D3m/R7/(D3s/R6)≤−0.98. When D3m/R7/(D3s/R6) is not within the range, there are risks that the curvature radius of the object-side surface of the fourth lens is too large or too small, the too thin edge thickness causes the fourth lens to break or deform during compression molding, and a too thick edge may cause the light rays to scatter at the edge of the fourth lens, affecting the imaging quality of the optical imaging lens assembly. By controlling D3m/R7/(D3s/R6) within a rational range, the curvature radius of the image-side surface of the third lens and the curvature radius of the object-side surface of the fourth lens are able to be maintained within a rational interval, such that the transition design between the third lens and the fourth lens is more rational, the edge thickness problem caused by the too large or too small curvature radius of the object-side surface of the fourth lens is avoided, and lens displacement and uneven stress distribution caused by a too large segment difference during assembly are reduced, thereby improving an assembly yield and stability of the optical imaging lens assembly.

In this implementation, a maximum height L of the lens barrel and a center thickness CT3 of the third lens meet: 2.72≤L/CT3≤3.37. L refers to a maximum height of the entire lens barrel, that is, a distance in an optical axis direction from the object-side end surface to the image-side end surface of the optical imaging lens assembly. By controlling L/CT3 within a rational range, a ratio of the third lens to the maximum height of the lens barrel is controlled. If an air gap between the third lens and the fourth lend is larger, selection matching of the third spacing element is easier, and there is more room for stray light improvement, such that the cooperation of the third lens and the fourth lens is able to be better controlled, thereby more facilitating the improvement of the quality of all stray light of the optical imaging lens assembly. Furthermore, the maximum height of the lens barrel not only affects the appearance and size of the optical imaging lens assembly, but also related to the strength and heat dissipation performance of the lens barrel. A higher L value facilitates improvement of the structural stability of the lens barrel, thereby reducing an impact of outer shocks to the lens barrel. Moreover, by controlling the ratio of L/CT3, the lens barrel with a compact structure, enough strength, and good heat dissipation may be designed without sacrificing the optimal performance of the third lens.

In this implementation, an outer diameter D0m of an image-side end surface of the lens barrel, an outer diameter D0s of an object-side end surface of the lens barrel, and a half of a diagonal length ImgH of an effectively pixel region on an imaging surface of the optical imaging lens assembly meet: 0.32≤(D0m−D0s)/ImgH≤1.17. When a wall thickness of the lens barrel is uneven, stress concentration easily occurs in the optical imaging lens assembly, leading to poor structural strength and impact resistance. By controlling (D0m−D0s)/ImgH within a rational range, requirements for controlling the appearance of the optical imaging lens assembly are met. The outer diameter D0m of the image-side end surface of the lens barrel is controlled cooperatively by a size of the imaging surface of the optical imaging lens assembly and a module motor, the outer diameter D0s of the object-side surface is mainly controlled by a module windowing and a size of an assembly bearing area, and these sizes commonly affect an appearance style of the optical imaging lens assembly. Under a condition that an optical effective aperture is fixed, if the evenness of the wall thickness of the lens barrel is better, the reliability of the optical imaging lens assembly is more stable.

In this implementation, an inner diameter dos of an object-side end surface of the lens barrel, an inner diameter d0m of an image-side end surface of the lens barrel, and a half of a diagonal length ImgH of an effectively pixel region on an imaging surface of the optical imaging lens assembly meet: 1.01≤(d0m−d0s)/ImgH≤1.30. When a ratio of (d0m−d0s)/ImgH is too small, a segment difference between the lenses is too small, resulting in difficulty in molding the first lens caused by a structural portion of the first lens or the second lens being too long, or instability in the assembly process of the optical imaging lens assembly caused by a structural portion of the third lens or the fourth lens being too short. When the ratio of (d0m-d0s)/ImgH is too large, the segment difference between the lenses is too large, results in insufficient strength of the spacing element, such that a stronger material is required, increasing the cost of the optical imaging lens assembly. By controlling (d0m−d0s)/ImgH within a rational range, a length of a lens structure of the optical imaging lens assembly may be controlled, such that optimization of a structural layout inside the optical imaging lens assembly is facilitated, an aberration is reduced, and the reliability and cost effectiveness of the optical imaging lens assembly are improved.

In this implementation, the third lens has a positive refractive power, and the fourth lens has a negative refractive power. Through the combined design of positive and negative focal lengths of the third lens and fourth lens, the optical imaging lens assembly is able to maintain good imaging performance within a wider wavelength range, the aberration is reduced, and the sharpness and color reproduction of an image are improved. Furthermore, the combination of positive and negative lenses may reduce a total length and size of the optical imaging lens assembly through optimization of an inner optical path, thereby achieving a compact structure. In this implementation, the object-side surface of the first lens is a concave surface, the image-side surface of the first lens is a convex surface, an object-side surface of the second lens is a convex surface, the image-side surface of the second lens is a concave surface, the object-side surface of the third lens is a convex surface, the image-side surface of the third lens is a convex surface, the object-side surface of the fourth lens is a convex surface, and an image-side surface of the fourth lens is a concave surface. Through configuration of surface shapes of the lenses, the chromatic aberration may be effectively corrected, especially a lateral color. Through the use of the combination of the concave surface and the convex surface, angles of refraction of different wavelengths of light rays may be controlled, causing the light rays to converge more accurately, and reducing color fringing or blurring caused by dispersion. Furthermore, that the object-side surface of the first lens is a concave surface may effectively expand an angle of incident light rays, that the image-side surface of the first lens is a convex surface facilitates light convergence, the second lens further controls a light trend, the third lens performs light convergence again, and the fourth lens finally diverges the light rays to the imaging surface. Such configuration facilitates accurate control of a direction of the light rays, ensuring that the light rays are able to reach the imaging surface in an optimal state.

In an implementation of the disclosure, the optical imaging lens assembly may perform simulation through software and/or tools such as ZEMAX, CODEV, etc. In an embodiment, the optical imaging lens assembly may perform simulation through the ZEMAX software. During the use of the above software and/or tools for simulation, a surface type of the surface of each lens may be properly adjusted according to the surface type of a self-contained surface of the software and/or tool used for simulation.

In this implementation, each lens may be selectively designed as an edge-trimmed lens. An outer diameter surface of the edge-trimmed lens has an edge-trimmed structure and a non-edge-trimmed structure, and an outer diameter of the edge-trimmed structure is less than an outer diameter of the non-edge-trimmed structure. The outer diameter of the edge-trimmed lens generally refers to the outer diameter of the non-edge-trimmed structure.

In this implementation, each spacing element may be selectively designed as an edge-trimmed spacing element. An outer ring surface of the edge-trimmed spacing element has an edge-trimmed portion and a non-edge-trimmed portion, and an outer diameter of the edge-trimmed portion is less than an outer diameter of the non-edge-trimmed portion. The outer diameter of the edge-trimmed spacing element generally refers to the largest outer diameter of the non-edge-trimmed portion.

In another implementation of the disclosure, an optical imaging lens assembly is provided. The optical imaging lens assembly has four lenses having refractive powers. The optical imaging lens assembly includes a lens assembly, a spacing element assembly, and a lens barrel. The lens assembly, from an object side to an image side of the optical imaging lens assembly, includes a first lens to a fourth lens, which are sequentially arranged at intervals; the spacing element assembly includes at least a first spacing element that is located between the first lens and a second lens and is in at least partial contact with an image-side surface of the first lens, a second spacing element that is located between the second lens and a third lens and is in at least partial contact with an image-side surface of the second lens, and a third spacing element that is located between the third lens and the fourth lens and is in at least partial contact with an image-side surface of the third lens; and the lens assembly and the spacing element assembly are accommodated in the lens barrel; a maximum thickness CP1 of the first spacing element along the optical axis, a center thickness CT1 of the first lens, and a center thickness CT2 of the second lens meet: 0.89≤CP1/(CT1+CT2)≤1.34; and a curvature radius R4 of an image-side surface of the second lens and an outer diameter D1m of an image-side surface of the first spacing element meet: 3.89≤D1m/R4≤4.29.

The optical imaging lens assembly of the disclosure uses four lenses having refractive powers, and the first lens to the fourth lens are sequentially arranged at intervals. In order to meet optimization of a surface type of the optical imaging lens assembly, by controlling the CP1/(CT1+CT2) within a rational range, the vector height of the image-side surface of the first lens, the vector height of the object-side surface of the second lens, and the air gap between the first lens and the second lens are able to be maintained within the rational range, the lenses have good molding effects, improvement of the stability of the optical imaging lens assembly during assembly is facilitated, and an assembly tolerance caused by non-matching shapes of the lenses is reduced. However, in this case, the refractive powers of the first lens and the second lens to light rays are weakened. By controlling D1m/R4 within a rational range, it ensures that the image-side surface of the second lens has an appropriate curvature radius to maintain good refractive capability, and a too large refraction angle of a light caused by a too small curvature radius of the image-side surface of the second lens is avoided at the same time, thereby reducing an aberration, and optimizing the imaging performance of the optical imaging lens assembly.

It is to be noted that, this implementation further includes other conditional expressions in the above implementations, which are not described herein again.

In yet another optional implementation of the disclosure, an optical imaging lens assembly is provided. The optical imaging lens assembly has four lenses having refractive powers. The optical imaging lens assembly includes a lens assembly, a spacing element assembly, and a lens barrel. The lens assembly, from an object side to an image side of the optical imaging lens assembly, includes a first lens to a fourth lens, which are sequentially arranged at intervals; the spacing element assembly includes at least a first spacing element that is located between the first lens and a second lens and is in at least partial contact with an image-side surface of the first lens, a second spacing element that is located between the second lens and a third lens and is in at least partial contact with an image-side surface of the second lens, and a third spacing element that is located between the third lens and the fourth lens and is in at least partial contact with an image-side surface of the third lens; and the lens assembly and the spacing element assembly are accommodated in the lens barrel; an effective focal length f4 of the fourth lens and a distance T34 between the image-side surface of the third lens and an object-side surface of the fourth lens on the optical axis meet: −231.04≤f4/T34≤−105.74; and a curvature radius R7 of an object-side surface of the fourth lens and an inner diameter d3m of an image-side surface of the third spacing element meet: 0.41≤R7/d3m≤0.46.

The optical imaging lens assembly of the disclosure uses four lenses having refractive powers, and the first lens to the fourth lens are sequentially arranged at intervals. In order to meet the assembly stability of the optical imaging lens assembly, by controlling f4/T34 within the rational range, an appropriate ratio of the focal length of the fourth lens to an air gap between the third lens and the fourth lens is ensured, such that optical parameter fluctuations caused by temperature changes or stress may be reduced, thereby improving the stability of the optical imaging lens assembly in different environments. Furthermore, correction of axial chromatic aberration and spherical aberration may be accurately controlled by rationally controlling f4/T34. By combining a negative focal length of the fourth lens with the specific air gap, lights with different wavelengths are consistently focused on the imaging surface, thereby improving image quality. By controlling R7/d3m within a rational range, a transition position of an effective diameter portion and structural portion of the object-side surface of the fourth lens is controlled to be more rational, avoiding a large difference between the center thickness and the edge thickness of the fourth lens, and optimizing the molding and assembly stability of the fourth lens, and at the same time, by controlling d3m, stray light rays between the lenses is intercepted to ensure that the light rays are able to be controlled efficiently when entering the fourth lens, and reduce the scattered lights, thereby improve the contrast of an image, and improving the efficiency and imaging quality of the optical imaging lens assembly.

It is to be noted that, this implementation further includes other conditional expressions in the above implementations, which are not described herein again.

The optical imaging lens assembly in the disclosure may use a plurality of lenses, for example, four lenses described above. In the disclosure, at least one of mirror surfaces of each lens is an aspheric surface. An aspheric lens has a characteristic that a curvature keeps changing from the center of the lens to the periphery of the lens. Unlike a spherical lens with a constant curvature from the center of the lens to the periphery of the lens, the aspheric lens has the characteristic of a better curvature radius and the advantages of improving distortions and improving astigmatic aberrations. By using the aspheric lens, aberrations during imaging may be eliminated as much as possible, thereby improving the imaging quality.

However, those skilled in the art should know that the number of the lenses forming the optical imaging lens assembly may be changed without departing from the technical solutions claimed in the disclosure to achieve each result and advantage described in the specification. For example, although descriptions are made in the implementation with four lenses as an example, the optical imaging lens assembly includes, but is not limited to, four lenses. If necessary, the optical imaging lens assembly may further include another number of lenses.

FIG. 1 is a schematic dimensioning diagram of an optical imaging lens assembly according to the disclosure. Parameters such as D1s, d3s, EP01, etc. are marked in FIG. 1, so as to clearly and visually understand the significance of the parameter. In order to facilitate description of the optical imaging lens assembly, as well as specific face shapes of specific lenses, these parameters are not shown in the drawings when specific embodiments are described subsequently.

Examples of specific surface types and parameters of the optical imaging lens assembly applicable to the above-mentioned implementation mode will further be described below with reference to the drawings.

It is to be noted that, any one of examples in Embodiment I to Embodiment VIII is applicable to all implementations of the disclosure.

### Embodiment I

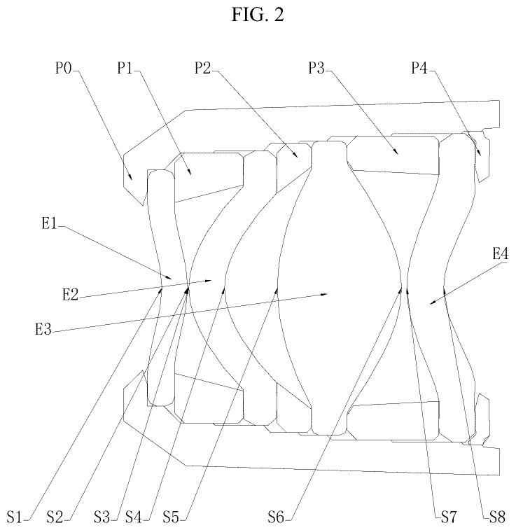

As shown in FIGS. 2 to 6, an optical imaging lens assembly according to Embodiment I of the disclosure is described. FIG. 2 is a schematic structural diagram of an optical imaging lens assembly according to Embodiment I.

As shown in FIG. 2, the optical imaging lens assembly includes, from an object side to an image side in sequence, a lens barrel P0, a first lens E1, a first spacing element P1, a second lens E2, a second spacing element P2, a third lens E3, a third spacing element P3, a fourth lens E4, and a fourth spacing element P4.

The first lens E1 has a negative refractive power; and an object-side surface S1 of the first lens is a concave surface, and an image-side surface S2 of the first lens is a convex surface. The second lens E2 has a positive refractive power; and an object-side surface S3 of the second lens is a convex surface, and an image-side surface S4 of the second lens is a concave surface. The third lens E3 has a positive refractive power; and an object-side surface S5 of the third lens is a convex surface, and an image-side surface S6 of the third lens is a convex surface. The fourth lens E4 has a negative refractive power; and an object-side surface S7 of the fourth lens is a convex surface, and an image-side surface S8 of the fourth lens is a concave surface. An optical filter has an object-side surface S9 of the optical filter and an image-side surface S10 of the optical filter; protective glass has an object-side surface S11 of the protective glass and an image-side surface S12 of the protective glass; and light rays from an object pass through S1 to S12 in sequence, and are finally imaged on an imaging surface S13.

Table 2 shows basic structure parameters of the optical imaging lens assembly in Embodiment I; and curvature radius, thickness/distance, effective radius, and focal length are all in millimeters (mm).

TABLE 2

| Surface | | Curvature | | Refractive | Abbe | Conic |
|---|---|---|---|---|---|---|
| number | Surface type | radius | Thickness | index | number | coefficient |
| OBJ | Spherical surface | Infinite | Infinite | | | |
| STO | Spherical surface | Infinite | 0.8078 | | | |
| S1 | Aspheric surface | −3.7719 | 1.0815 | 1.52 | 64.00 | −0.7936 |
| S2 | Aspheric surface | −4.3237 | 0.0448 | | | 0.1646 |
| S3 | Aspheric surface | 2.9748 | 1.5020 | 1.66 | 20.40 | −0.9807 |
| S4 | Aspheric surface | 2.5590 | 2.2303 | | | −1.0108 |
| S5 | Aspheric surface | 8.2076 | 5.2133 | 1.52 | 64.00 | 0.2261 |
| S6 | Aspheric surface | −4.5000 | 0.2220 | | | −0.8776 |
| S7 | Aspheric surface | 4.3664 | 1.5469 | 1.66 | 20.40 | −0.6124 |
| S8 | Aspheric surface | 2.9105 | 1.3335 | | | −1.0164 |
| S9 | Spherical surface | Infinite | 0.5000 | 1.52 | 64.20 | |
| S10 | Spherical surface | Infinite | 0.5136 | | | |
| S11 | Spherical surface | Infinite | 0.5000 | 1.52 | 64.20 | |
| S12 | Spherical surface | Infinite | 0.4983 | | | |
| S13 | Spherical surface | Infinite | | | | |

In Embodiment I, the object-side surfaces and image-side surfaces of any one of the first lens E1 to the fourth lens E4 both are aspheric surfaces; and the surface type of each aspheric lens may be limited by using, but not limited to, the following aspheric equation.

$$x = \frac{c {h}^{2}}{1 + \sqrt{1 - ( k + 1 ) {c}^{2} {h}^{2}}} + \sum A i {h}^{i} ; \qquad ( 1 )$$

Where x is a distance vector height from the vertex of the aspheric surface when the height of the aspheric surface in an optical axis direction is h; c is a paraxial curvature of the aspheric surface, c=1/R (namely, the paraxial curvature c is the reciprocal of the curvature radius R in Table 2); k is the conic coefficient; and Ai is a correction factor for an ith order of the aspheric surface. Table 3 blow provides high order coefficients A4, A6, A8, A10, A12, A14, A16, A18, A20, A22, A24, A26, and A28 applied to various aspheric surfaces S1-S8 in Embodiment I.

TABLE 3

| Surface number | A4 | A6 | A8 | A10 | A12 | A14 | A16 |
|---|---|---|---|---|---|---|---|
| S1 | 2.23E−02 | −5.25E−03 | 1.24E−03 | −2.29E−04 | 3.03E−05 | −2.74E−06 | 1.59E−07 |
| S2 | 1.30E−02 | −9.44E−04 | 1.35E−05 | 2.38E−05 | −5.07E−06 | 5.51E−07 | −3.41E−08 |
| S3 | −9.09E−03 | 1.79E−03 | −3.58E−04 | 5.89E−05 | −7.31E−06 | 6.61E−07 | −4.25E−08 |
| S4 | −1.42E−02 | 3.20E−03 | −5.92E−04 | 4.22E−05 | 1.66E−05 | −6.93E−06 | 1.36E−06 |
| S5 | −1.13E−04 | −8.38E−05 | 1.69E−05 | −2.10E−06 | 1.63E−07 | −7.94E−09 | 2.39E−10 |
| S6 | −2.58E−03 | 1.51E−03 | −2.81E−04 | 3.16E−05 | −2.29E−06 | 1.07E−07 | −3.11E−09 |
| S7 | −7.72E−03 | 3.35E−04 | 1.74E−04 | −2.16E−05 | −9.78E−06 | 3.77E−06 | −6.34E−07 |
| S8 | −7.54E−03 | −4.04E−03 | 2.90E−03 | −1.02E−03 | 2.28E−04 | −3.53E−05 | 3.87E−06 |

| Surface number | A18 | A20 | A22 | A24 | A26 | A28 |
|---|---|---|---|---|---|---|
| S1 | −5.31E−09 | 7.74E−11 | 0.00E+00 | 0.00E+00 | 0.00E+00 | 0.00E+00 |
| S2 | 1.15E−09 | −1.59E−11 | 0.00E+00 | 0.00E+00 | 0.00E+00 | 0.00E+00 |
| S3 | 1.88E−09 | −5.42E−11 | 9.02E−13 | −6.35E−15 | −4.56E−18 | 0.00E+00 |
| S4 | −1.68E−07 | 1.39E−08 | −7.66E−10 | 2.70E−11 | −5.54E−13 | 5.02E−15 |
| S5 | −4.19E−12 | 3.40E−14 | 0.00E+00 | 0.00E+00 | 0.00E+00 | 0.00E+00 |
| S6 | 5.09E−11 | −3.57E−13 | 0.00E+00 | 0.00E+00 | 0.00E+00 | 0.00E+00 |
| S7 | 6.46E−08 | −4.29E−09 | 1.88E−10 | −5.24E−12 | 8.47E−14 | −6.03E−16 |
| S8 | −3.05E−07 | 1.72E−08 | −6.72E−10 | 1.75E−11 | −2.71E−13 | 1.90E−15 |

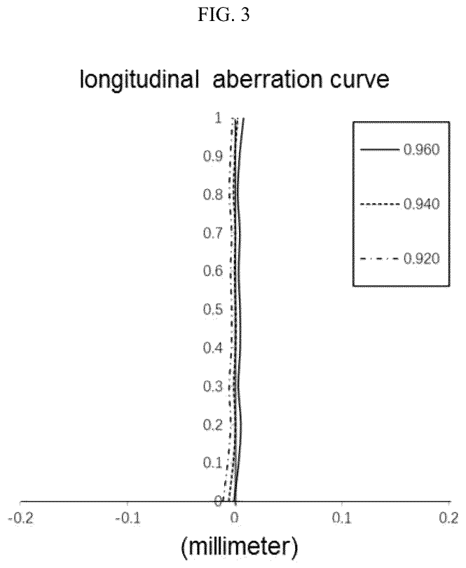

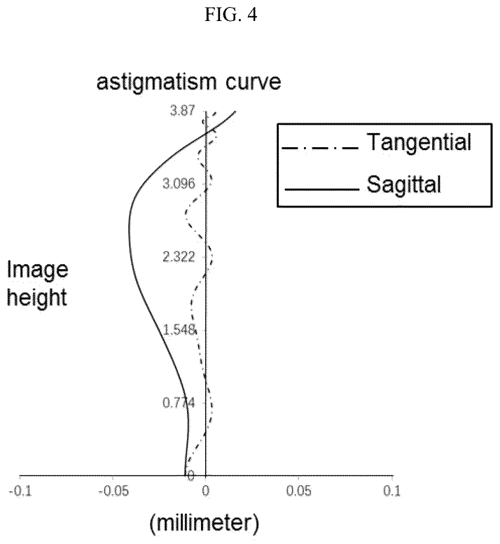

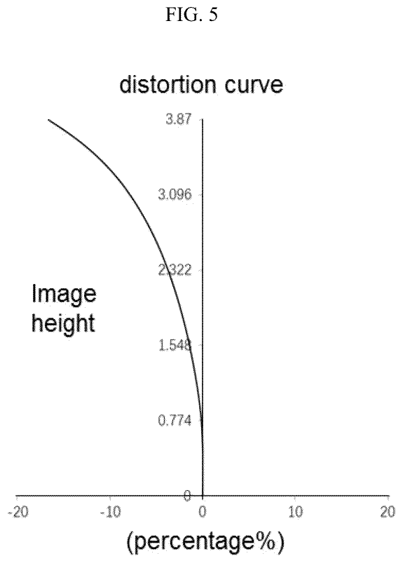

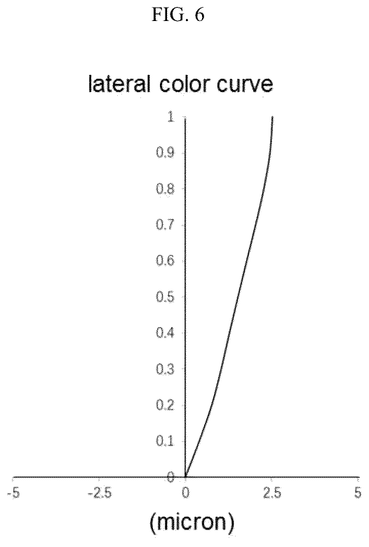

FIG. 3 shows a longitudinal aberration curve of the optical imaging lens assembly in Embodiment I; and the longitudinal aberration curve represents deviation of a convergence focal point after light with different wavelengths passes through the optical imaging lens assembly. FIG. 4 shows an astigmatism curve of the optical imaging lens assembly in Embodiment I; and the astigmatism curve represents a tangential image surface curvature and a sagittal image surface curvature. FIG. 5 shows a distortion curve of the optical imaging lens assembly in Embodiment I; and the distortion curve represents distortion values corresponding to different FOVs. FIG. 6 shows a lateral color curve of the optical imaging lens assembly in Embodiment I, which indicates an extent to which focusing points of different wavelengths of lights do not coincide exactly.

According to FIGS. 3 to 6, it may be learned that, the optical imaging lens assembly provided in Embodiment I is able to achieve desirable imaging quality.

### Embodiment II

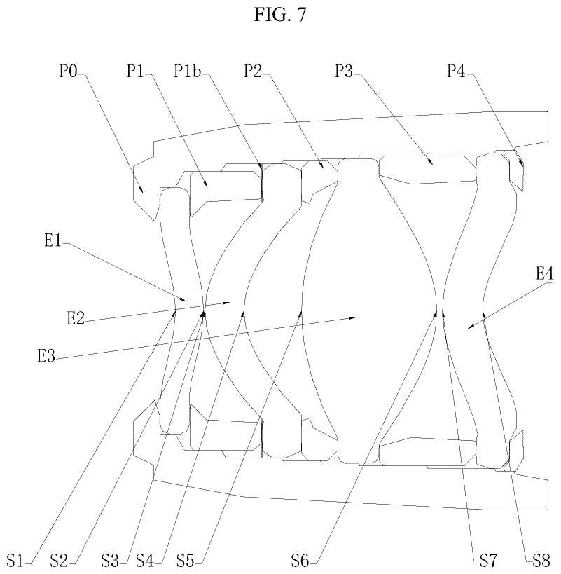

As shown in FIG. 7, an optical imaging lens assembly according to Embodiment II of the disclosure is described. A difference between this embodiment and Embodiment I lies in the different distances and thicknesses between spacing elements, lenses, lens barrels P0, and so on.

FIG. 7 is a schematic structural diagram of an optical imaging lens assembly according to Embodiment II. For the sake of brevity, a portion of the description similar to Embodiment I will be omitted. In this embodiment, a small outer diameter of each lens and spacing element facilitates miniaturized design of the optical imaging lens assembly.

### Embodiment III

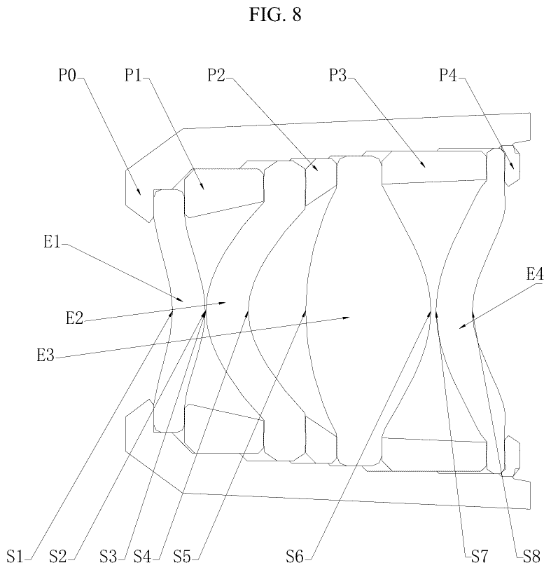

As shown in FIGS. 8 to 12, an optical imaging lens assembly according to Embodiment III of the disclosure is described. FIG. 8 is a schematic structural diagram of an optical imaging lens assembly according to Embodiment III.

As shown in FIG. 8, the optical imaging lens assembly includes, from an object side to an image side in sequence, a lens barrel P0, a first lens E1, a first spacing element P1, a second lens E2, a second spacing element P2, a third lens E3, a third spacing element P3, a fourth lens E4, and a fourth spacing element P4.

The first lens E1 has a positive refractive power; and an object-side surface S1 of the first lens is a concave surface, and an image-side surface S2 of the first lens is a convex surface. The second lens E2 has a positive refractive power; and an object-side surface S3 of the second lens is a convex surface, and an image-side surface S4 of the second lens is a concave surface. The third lens E3 has a positive refractive power; and an object-side surface S5 of the third lens is a convex surface, and an image-side surface S6 of the third lens is a convex surface. The fourth lens E4 has a negative refractive power; and an object-side surface S7 of the fourth lens is a convex surface, and an image-side surface S8 of the fourth lens is a concave surface. An optical filter has an object-side surface S9 of the optical filter and an image-side surface S10 of the optical filter; protective glass has an object-side surface S11 of the protective glass and an image-side surface S12 of the protective glass; and light rays from an object pass through S1 to S12 in sequence, and are finally imaged on an imaging surface S13.

Table 4 shows basic structure parameters of the optical imaging lens assembly in Embodiment III; and curvature radius, thickness/distance, effective radius, and focal length are all in millimeters (mm).

TABLE 4

| Surface | | Curvature | | Refractive | Abbe | Conic |
|---|---|---|---|---|---|---|
| number | Surface type | radius | Thickness | index | number | coefficient |
| OBJ | Spherical surface | Infinite | Infinite | | | |
| STO | Spherical surface | Infinite | 0.9152 | | | |
| S1 | Aspheric surface | −3.8254 | 1.2781 | 1.52 | 64.00 | −0.7005 |
| S2 | Aspheric surface | −3.9762 | 0.0250 | | | 0.0924 |
| S3 | Aspheric surface | 3.0519 | 1.6594 | 1.66 | 20.40 | −0.9779 |
| S4 | Aspheric surface | 2.4704 | 2.2617 | | | −1.0214 |
| S5 | Aspheric surface | 9.5092 | 4.9202 | 1.52 | 64.00 | 0.5918 |
| S6 | Aspheric surface | −4.5000 | 0.1990 | | | −0.9030 |
| S7 | Aspheric surface | 4.2290 | 1.4265 | 1.66 | 20.40 | −0.5666 |
| S8 | Aspheric surface | 3.0146 | 1.2971 | | | −1.0172 |
| S9 | Spherical surface | Infinite | 0.5000 | 1.52 | 64.20 | |
| S10 | Spherical surface | Infinite | 0.5136 | | | |
| S11 | Spherical surface | Infinite | 0.5000 | 1.52 | 64.20 | |
| S12 | Spherical surface | Infinite | 0.4998 | | | |
| S13 | Spherical surface | Infinite | | | | |

Table 5 shows higher-order coefficients applied to each of the aspheric surfaces in Embodiment III; and each of the aspheric surface types may be limited by the equation (1) provided in Embodiment I. In this embodiment, the object-side surfaces and image-side surfaces of the first lens to the fourth lens are aspheric.

TABLE 5

| Surface number | A4 | A6 | A8 | A10 | A12 | A14 | A16 |
|---|---|---|---|---|---|---|---|
| S1 | 1.88E−02 | −3.98E−03 | 8.37E−04 | −1.33E−04 | 1.47E−05 | −1.06E−06 | 4.62E−08 |
| S2 | 1.28E−02 | −1.45E−03 | 3.20E−04 | −7.05E−05 | 1.32E−05 | −1.69E−06 | 1.35E−07 |
| S3 | −6.57E−03 | 9.14E−04 | −1.40E−04 | 2.02E−05 | −2.48E−06 | 2.37E−07 | −1.64E−08 |
| S4 | −1.51E−02 | 3.55E−03 | −6.99E−04 | 5.49E−05 | 1.99E−05 | −8.80E−06 | 1.79E−06 |
| S5 | −1.42E−04 | −1.04E−05 | −3.53E−06 | 1.21E−06 | −1.72E−07 | 1.35E−08 | −6.26E−10 |
| S6 | −1.76E−03 | 1.30E−03 | −2.52E−04 | 2.90E−05 | −2.12E−06 | 9.91E−08 | −2.82E−09 |
| S7 | −7.29E−03 | 3.40E−04 | 2.98E−04 | −1.25E−04 | 2.69E−05 | −3.81E−06 | 3.79E−07 |
| S8 | −8.86E−03 | −1.53E−03 | 1.34E−03 | −4.57E−04 | 9.80E−05 | −1.45E−05 | 1.51E−06 |

| Surface number | A18 | A20 | A22 | A24 | A26 | A28 |
|---|---|---|---|---|---|---|
| S1 | −1.04E−09 | 7.70E−12 | 0.00E+00 | 0.00E+00 | 0.00E+00 | 0.00E+00 |
| S2 | −5.97E−09 | 1.13E−10 | 0.00E+00 | 0.00E+00 | 0.00E+00 | 0.00E+00 |
| S3 | 7.78E−10 | −2.34E−11 | 3.87E−13 | −2.53E−15 | −1.68E−18 | 0.00E+00 |
| S4 | −2.29E−07 | 1.95E−08 | −1.11E−09 | 4.07E−11 | −8.65E−13 | 8.13E−15 |
| S5 | 1.59E−11 | −1.69E−13 | 0.00E+00 | 0.00E+00 | 0.00E+00 | 0.00E+00 |
| S6 | 4.34E−11 | −2.63E−13 | 0.00E+00 | 0.00E+00 | 0.00E+00 | 0.00E+00 |
| S7 | −2.69E−08 | 1.37E−09 | −4.80E−11 | 1.11E−12 | −1.53E−14 | 9.36E−17 |
| S8 | −1.14E−07 | 6.07E−09 | −2.25E−10 | 5.48E−12 | −7.91E−14 | 5.11E−16 |

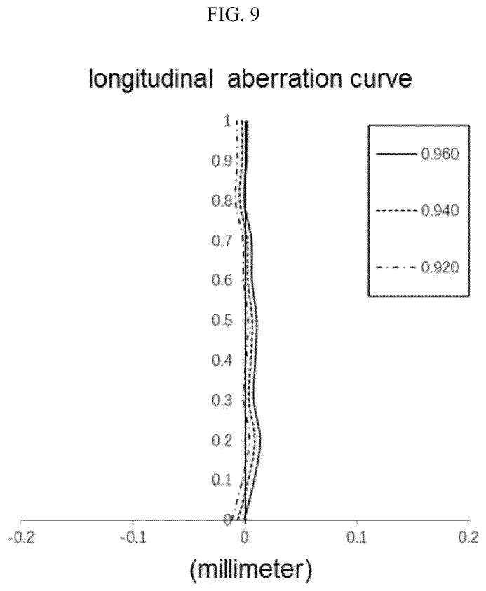

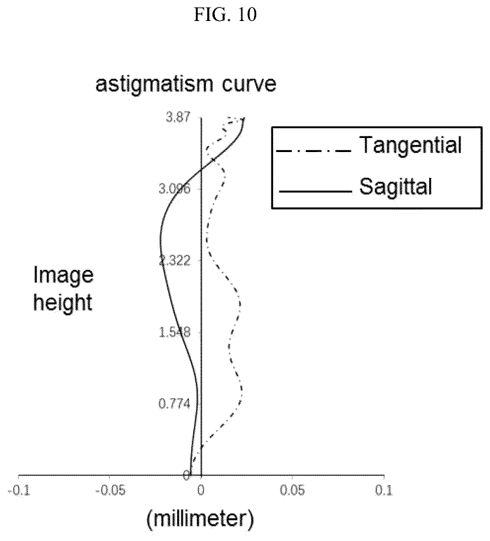

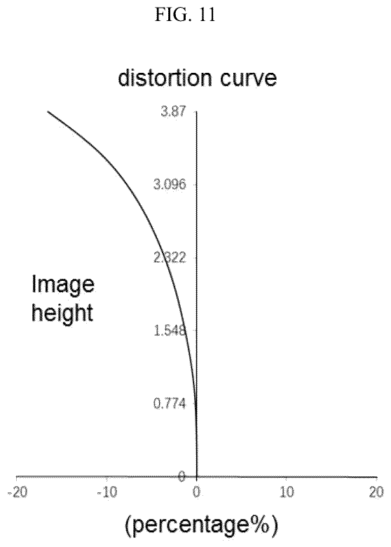

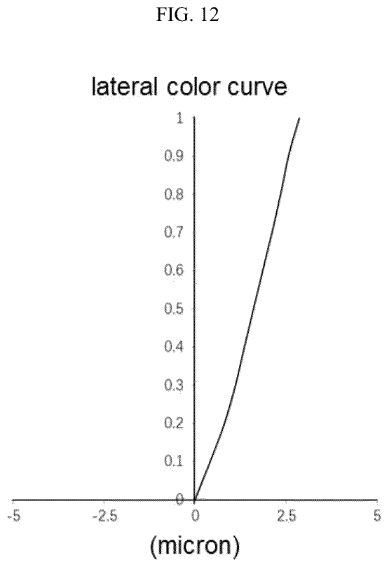

FIG. 9 shows a longitudinal aberration curve of the optical imaging lens assembly in Embodiment III; and the longitudinal aberration curve represents deviation of a convergence focal point after light with different wavelengths passes through the optical imaging lens assembly. FIG. 10 shows an astigmatism curve of the optical imaging lens assembly in Embodiment III; and the astigmatism curve represents a tangential image surface curvature and a sagittal image surface curvature. FIG. 11 shows a distortion curve of the optical imaging lens assembly in Embodiment III; and the distortion curve represents distortion values corresponding to different FOVs. FIG. 12 shows a lateral color curve of the optical imaging lens assembly in Embodiment III, which indicates an extent to which focusing points of different wavelengths of lights do not coincide exactly.

According to FIGS. 9 to 12, it may be learned that, the optical imaging lens assembly provided in Embodiment III is able to achieve desirable imaging quality.

### Embodiment IV

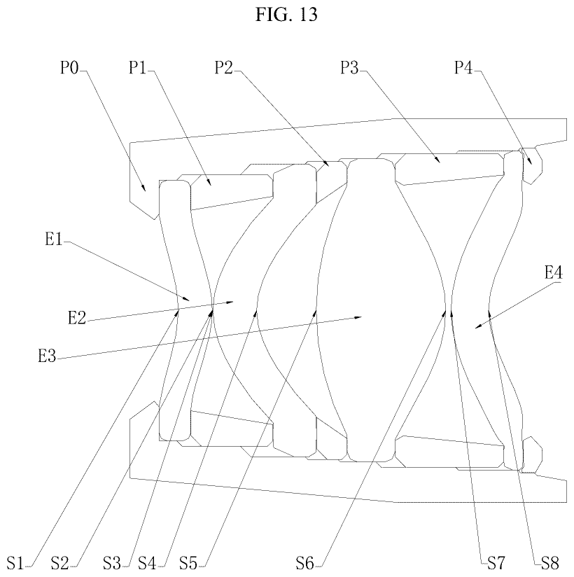

As shown in FIG. 13, an optical imaging lens assembly according to Embodiment IV of the disclosure is described. A difference between this embodiment and Embodiment III lies in the different distances and thicknesses between spacing elements, lenses, lens barrels P0, and so on.

FIG. 13 is a schematic structural diagram of an optical imaging lens assembly according to Embodiment IV. For the sake of brevity, a portion of the description similar to Embodiment III will be omitted. In this embodiment, the difference between the outer diameter and the inner diameter of the spacing element is small, which facilitates the transmission of light.

### Embodiment V

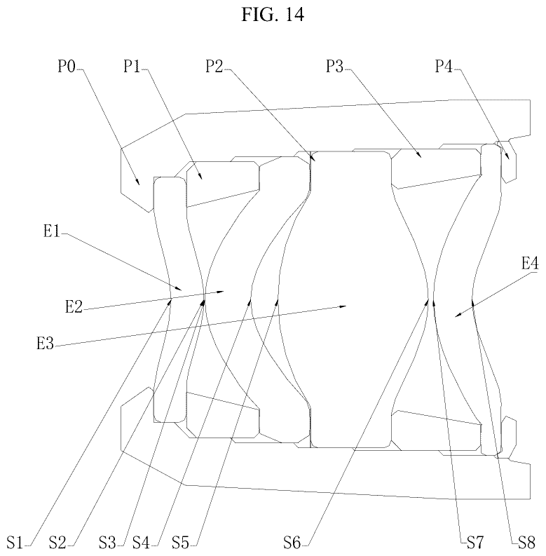

As shown in FIGS. 14 to 18, an optical imaging lens assembly according to Embodiment V of the disclosure is described. FIG. 14 is a schematic structural diagram of an optical imaging lens assembly according to Embodiment V.

As shown in FIG. 14, the optical imaging lens assembly includes, from an object side to an image side in sequence, a lens barrel P0, a first lens E1, a first spacing element P1, a second lens E2, a second spacing element P2, a third lens E3, a third spacing element P3, a fourth lens E4, and a fourth spacing element P4.

The first lens E1 has a positive refractive power; and an object-side surface S1 of the first lens is a concave surface, and an image-side surface S2 of the first lens is a convex surface. The second lens E2 has a negative refractive power; and an object-side surface S3 of the second lens is a convex surface, and an image-side surface S4 of the second lens is a concave surface. The third lens E3 has a positive refractive power; and an object-side surface S5 of the third lens is a convex surface, and an image-side surface S6 of the third lens is a convex surface. The fourth lens E4 has a negative refractive power; and an object-side surface S7 of the fourth lens is a convex surface, and an image-side surface S8 of the fourth lens is a concave surface. An optical filter has an object-side surface S9 of the optical filter and an image-side surface S10 of the optical filter; protective glass has an object-side surface S11 of the protective glass and an image-side surface S12 of the protective glass; and light rays from an object pass through S1 to S12 in sequence, and are finally imaged on an imaging surface S13.

Table 6 shows basic structure parameters of the optical imaging lens assembly in Embodiment V; and curvature radius, thickness/distance, effective radius, and focal length are all in millimeters (mm).

TABLE 6

| Surface | | Curvature | | Refractive | Abbe | Conic |
|---|---|---|---|---|---|---|
| number | Surface type | radius | Thickness | index | number | coefficient |
| OBJ | Spherical surface | Infinite | Infinite | | | |
| STO | Spherical surface | Infinite | 0.8854 | | | |
| S1 | Aspheric surface | −3.9061 | 1.2994 | 1.52 | 64.00 | −0.6946 |
| S2 | Aspheric surface | −3.9429 | 0.0385 | | | 0.0483 |
| S3 | Aspheric surface | 3.3393 | 1.8152 | 1.66 | 20.40 | −0.9590 |
| S4 | Aspheric surface | 2.4778 | 1.0811 | | | −1.0352 |
| S5 | Aspheric surface | 7.5722 | 5.9655 | 1.52 | 64.00 | 0.7066 |
| S6 | Aspheric surface | −4.5041 | 0.1969 | | | −1.0264 |
| S7 | Aspheric surface | 4.4407 | 1.5371 | 1.66 | 20.40 | −0.4985 |
| S8 | Aspheric surface | 3.1633 | 1.1631 | | | −1.0030 |
| S9 | Spherical surface | Infinite | 0.5000 | 1.52 | 64.20 | |
| S10 | Spherical surface | Infinite | 0.5136 | | | |
| S11 | Spherical surface | Infinite | 0.5000 | 1.52 | 64.20 | |
| S12 | Spherical surface | Infinite | 0.4993 | | | |
| S13 | Spherical surface | Infinite | | | | |

Table 7 shows higher-order coefficients applied to each of the aspheric surfaces in Embodiment V; and each of the aspheric surface types may be limited by the equation (1) provided in Embodiment I. In this embodiment, the object-side surfaces and image-side surfaces of the first lens to the fourth lens are aspheric.

TABLE 7

| Surface number | A4 | A6 | A8 | A10 | A12 | A14 | A16 |
|---|---|---|---|---|---|---|---|
| S1 | 1.61E−02 | −2.90E−03 | 5.58E−04 | −8.05E−05 | 7.96E−06 | −4.94E−07 | 1.63E−08 |
| S2 | 1.24E−02 | −8.90E−04 | 8.84E−05 | −6.20E−06 | 1.52E−06 | −3.28E−07 | 3.64E−08 |
| S3 | −5.55E−03 | 7.07E−04 | −1.11E−04 | 1.67E−05 | −2.05E−06 | 1.87E−07 | −1.21E−08 |
| S4 | −1.55E−02 | 3.63E−03 | −7.14E−04 | 5.81E−05 | 1.90E−05 | −8.55E−06 | 1.74E−06 |
| S5 | −4.81E−04 | 4.91E−05 | 8.09E−06 | −3.59E−06 | 5.40E−07 | −4.43E−08 | 2.07E−09 |
| S6 | −3.73E−03 | 2.42E−03 | −5.62E−04 | 8.11E−05 | −7.65E−06 | 4.73E−07 | −1.85E−08 |
| S7 | −9.62E−03 | 1.82E−03 | −1.69E−04 | −2.63E−05 | 1.15E−05 | −1.93E−06 | 1.98E−07 |
| S8 | −1.10E−02 | −2.11E−04 | 8.22E−04 | −3.26E−04 | 7.52E−05 | −1.16E−05 | 1.26E−06 |

| Surface number | A18 | A20 | A22 | A24 | A26 | A28 |
|---|---|---|---|---|---|---|
| S1 | −1.42E−10 | −3.93E−12 | 0.00E+00 | 0.00E+00 | 0.00E+00 | 0.00E+00 |
| S2 | −1.98E−09 | 4.29E−11 | 0.00E+00 | 0.00E+00 | 0.00E+00 | 0.00E+00 |
| S3 | 5.33E−10 | −1.49E−11 | 2.31E−13 | −1.44E−15 | −9.13E−19 | 0.00E+00 |
| S4 | −2.22E−07 | 1.88E−08 | −1.07E−09 | 3.87E−11 | −8.17E−13 | 7.62E−15 |
| S5 | −5.22E−11 | 5.50E−13 | 0.00E+00 | 0.00E+00 | 0.00E+00 | 0.00E+00 |
| S6 | 4.17E−10 | −4.12E−12 | 0.00E+00 | 0.00E+00 | 0.00E+00 | 0.00E+00 |
| S7 | −1.37E−08 | 6.43E−10 | −2.04E−11 | 4.17E−13 | −4.91E−15 | 2.52E−17 |
| S8 | −9.73E−08 | 5.31E−09 | −2.01E−10 | 5.00E−12 | −7.39E−14 | 4.90E−16 |

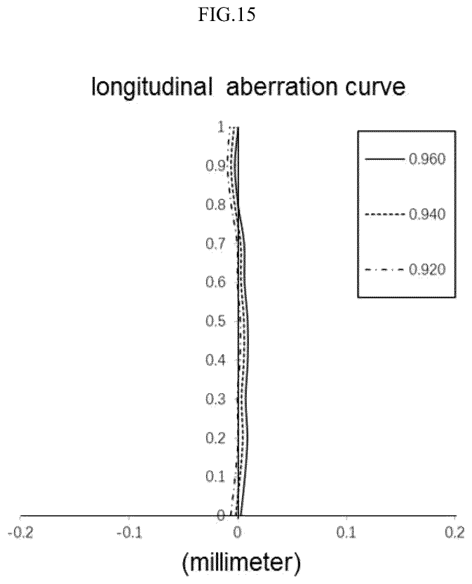

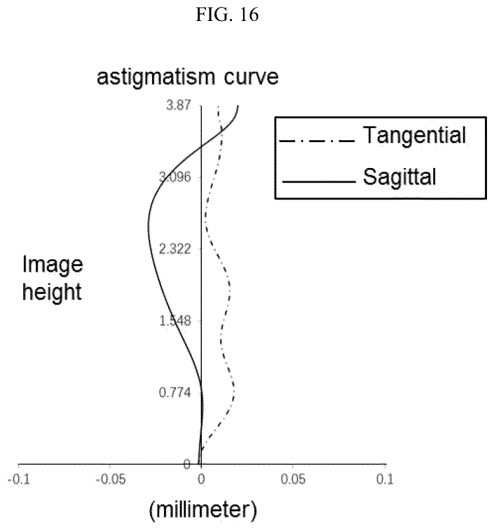

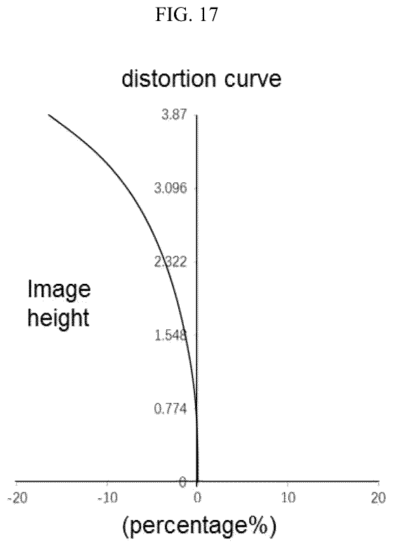

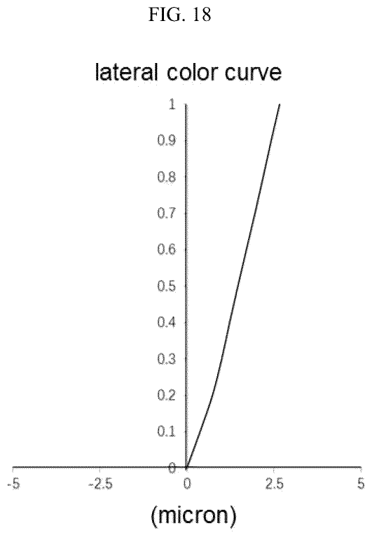

FIG. 15 shows a longitudinal aberration curve of the optical imaging lens assembly in Embodiment V; and the longitudinal aberration curve represents deviation of a convergence focal point after light with different wavelengths passes through the optical imaging lens assembly. FIG. 16 shows an astigmatism curve of the optical imaging lens assembly in Embodiment V; and the astigmatism curve represents a tangential image surface curvature and a sagittal image surface curvature. FIG. 17 shows a distortion curve of the optical imaging lens assembly in Embodiment V; and the distortion curve represents distortion values corresponding to different fields of view. FIG. 18 shows a lateral color curve of the optical imaging lens assembly in Embodiment V, which indicates an extent to which focusing points of different wavelengths of lights do not coincide exactly.

According to FIGS. 15 to 18, it may be learned that, the optical imaging lens assembly provided in Embodiment V is able to achieve desirable imaging quality.

### Embodiment VI

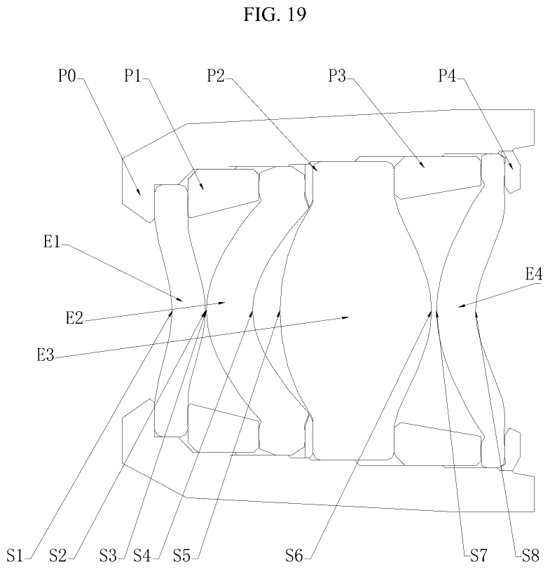

As shown in FIG. 19, an optical imaging lens assembly according to Embodiment VI of the disclosure is described. A difference between this embodiment and Embodiment V lies in the different distances and thicknesses between spacing elements, lenses, lens barrels P0, and so on.

FIG. 19 is a schematic structural diagram of an optical imaging lens assembly according to Embodiment VI. For the sake of brevity, a portion of the description similar to Embodiment V will be omitted. In this embodiment, the second spacing element has a certain thickness rather than a thin sheet-like spacing element, such that the shapes of the second lens and third lens meet the processing while axial spacing is complemented to ensure support stability.

### Embodiment VII

As shown in FIGS. 20 to 24, an optical imaging lens assembly according to Embodiment VII of the disclosure is described. FIG. 20 is a schematic structural diagram of an optical imaging lens assembly according to Embodiment VII.

As shown in FIG. 20, the optical imaging lens assembly includes, from an object side to an image side in sequence, a lens barrel P0, a first lens E1, a first spacing element P1, a second lens E2, a second spacing element P2, a third lens E3, a third spacing element P3, a fourth lens E4, and a fourth spacing element P4.

The first lens E1 has a positive refractive power; and an object-side surface S1 of the first lens is a concave surface, and an image-side surface S2 of the first lens is a convex surface. The second lens E2 has a positive refractive power; and an object-side surface S3 of the second lens is a convex surface, and an image-side surface S4 of the second lens is a concave surface. The third lens E3 has a positive refractive power; and an object-side surface S5 of the third lens is a convex surface, and an image-side surface S6 of the third lens is a convex surface. The fourth lens E4 has a negative refractive power; and an object-side surface S7 of the fourth lens is a convex surface, and an image-side surface S8 of the fourth lens is a concave surface. An optical filter has an object-side surface S9 of the optical filter and an image-side surface S10 of the optical filter; protective glass has an object-side surface S11 of the protective glass and an image-side surface S12 of the protective glass; and light rays from an object pass through S1 to S12 in sequence, and are finally imaged on an imaging surface S13.

Table 8 shows basic structure parameters of the optical imaging lens assembly in Embodiment VII; and curvature radius, thickness/distance, effective radius, and focal length are all in millimeters (mm).

TABLE 8

| Surface | | Curvature | | Refractive | Abbe | Conic |
|---|---|---|---|---|---|---|
| number | Surface type | radius | Thickness | index | number | coefficient |
| OBJ | Spherical surface | Infinite | Infinite | | | |
| STO | Spherical surface | Infinite | 0.8750 | | | |
| S1 | Aspheric surface | −3.8338 | 0.9909 | 1.52 | 64.00 | −0.7287 |
| S2 | Aspheric surface | −3.9868 | 0.3500 | | | 0.0838 |
| S3 | Aspheric surface | 3.0333 | 1.5684 | 1.66 | 20.40 | −0.9843 |
| S4 | Aspheric surface | 2.4811 | 2.1965 | | | −1.0294 |
| S5 | Aspheric surface | 9.0213 | 5.0356 | 1.52 | 64.00 | 0.4473 |
| S6 | Aspheric surface | −4.4953 | 0.1385 | | | −0.9034 |
| S7 | Aspheric surface | 4.2723 | 1.5150 | 1.66 | 20.40 | −0.5650 |
| S8 | Aspheric surface | 3.0427 | 1.3122 | | | −1.0253 |
| S9 | Spherical surface | Infinite | 0.5000 | 1.52 | 64.20 | |
| S10 | Spherical surface | Infinite | 0.5136 | | | |
| S11 | Spherical surface | Infinite | 0.5000 | 1.52 | 64.20 | |
| S12 | Spherical surface | Infinite | 0.4985 | | | |
| S13 | Spherical surface | Infinite | | | | |

Table 9 shows higher-order coefficients applied to each of the aspheric surfaces in Embodiment VII; and each of the aspheric surface types may be limited by the equation (1) provided in Embodiment I. In this embodiment, the object-side surfaces and image-side surfaces of the first lens to the fourth lens are aspheric.

TABLE 9

| Surface number | A4 | A6 | A8 | A10 | A12 | A14 | A16 |
|---|---|---|---|---|---|---|---|
| S1 | 1.69E−02 | −3.23E−03 | 6.69E−04 | −1.08E−04 | 1.24E−05 | −9.57E−07 | 4.58E−08 |
| S2 | 1.09E−02 | −4.07E−04 | −7.15E−05 | 3.49E−05 | −5.81E−06 | 5.21E−07 | −2.36E−08 |
| S3 | −7.07E−03 | 1.27E−03 | −2.58E−04 | 4.27E−05 | −5.16E−06 | 4.37E−07 | −2.57E−08 |
| S4 | −1.29E−02 | 2.74E−03 | −5.10E−04 | 3.65E−05 | 1.43E−05 | −5.83E−06 | 1.12E−06 |
| S5 | −3.51E−04 | −5.69E−06 | −2.39E−07 | 3.40E−07 | −5.38E−08 | 4.28E−09 | −1.96E−10 |
| S6 | −2.22E−03 | 1.41E−03 | −2.67E−04 | 3.03E−05 | −2.20E−06 | 1.03E−07 | −2.93E−09 |
| S7 | −7.21E−03 | 4.73E−04 | 2.24E−04 | −1.01E−04 | 2.17E−05 | −3.03E−06 | 2.96E−07 |
| S8 | −8.40E−03 | −1.43E−03 | 1.20E−03 | −3.98E−04 | 8.30E−05 | −1.19E−05 | 1.22E−06 |

| Surface number | A18 | A20 | A22 | A24 | A26 | A28 |
|---|---|---|---|---|---|---|
| S1 | −1.19E−09 | 1.21E−11 | 0.00E+00 | 0.00E+00 | 0.00E+00 | 0.00E+00 |
| S2 | 3.67E−10 | 4.39E−12 | 0.00E+00 | 0.00E+00 | 0.00E+00 | 0.00E+00 |
| S3 | 1.03E−09 | −2.67E−11 | 4.05E−13 | −2.65E−15 | −1.77E−18 | 0.00E+00 |
| S4 | −1.34E−07 | 1.08E−08 | −5.78E−10 | 1.99E−11 | −3.97E−13 | 3.49E−15 |
| S5 | 4.99E−12 | −5.31E−14 | 0.00E+00 | 0.00E+00 | 0.00E+00 | 0.00E+00 |
| S6 | 4.60E−11 | −2.96E−13 | 0.00E+00 | 0.00E+00 | 0.00E+00 | 0.00E+00 |
| S7 | −2.06E−08 | 1.02E−09 | −3.53E−11 | 8.00E−13 | −1.07E−14 | 6.41E−17 |

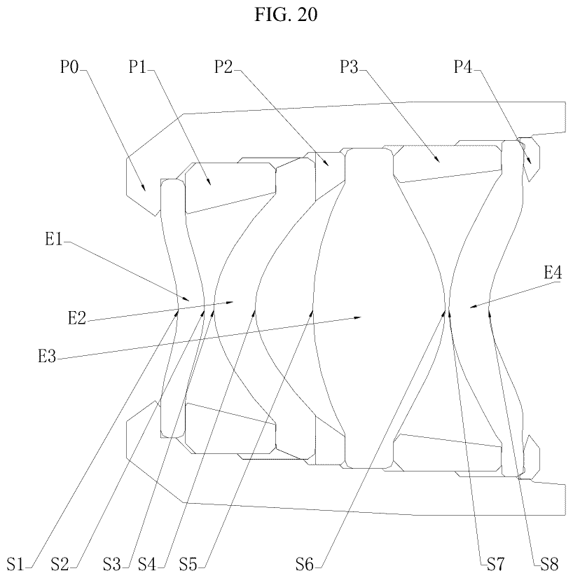

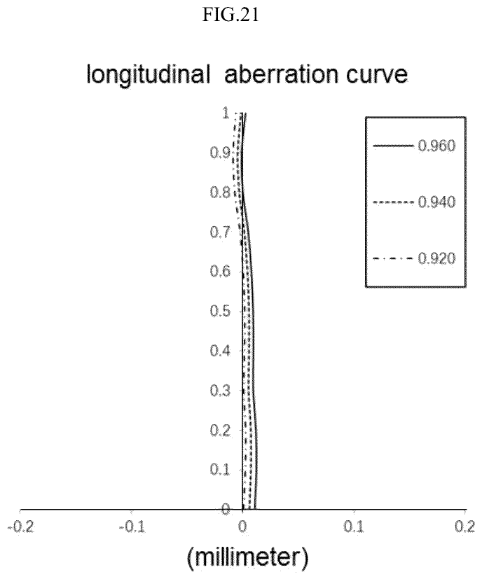

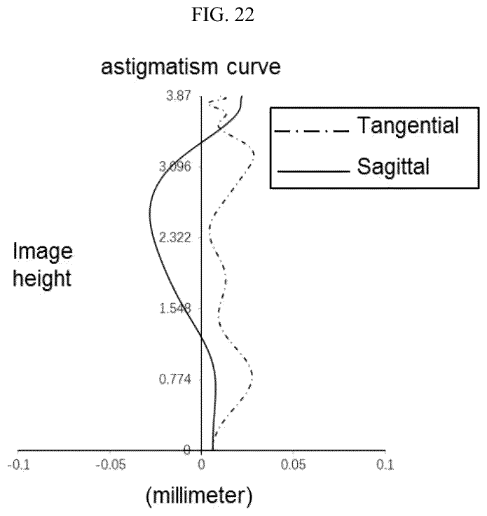

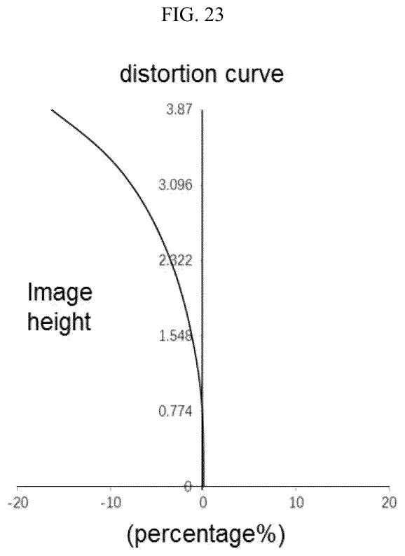

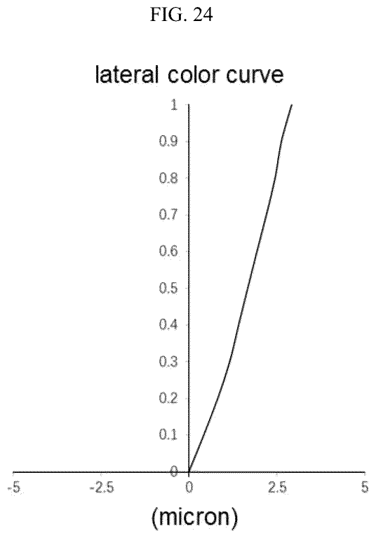

FIG. 21 shows a longitudinal aberration curve of the optical imaging lens assembly in Embodiment VII; and the longitudinal aberration curve represents deviation of a convergence focal point after light with different wavelengths passes through the optical imaging lens assembly. FIG. 22 shows an astigmatism curve of the optical imaging lens assembly in Embodiment VII; and the astigmatism curve represents a tangential image surface curvature and a sagittal image surface curvature. FIG. 23 shows a distortion curve of the optical imaging lens assembly in Embodiment VII; and the distortion curve represents distortion values corresponding to different FOVs. FIG. 24 shows a lateral color curve of the optical imaging lens assembly in Embodiment VII, which indicates an extent to which focusing points of different wavelengths of lights do not coincide exactly.

According to FIGS. 21 to 24, it may be learned that, the optical imaging lens assembly provided in Embodiment VII is able to achieve desirable imaging quality.

### Embodiment VIII

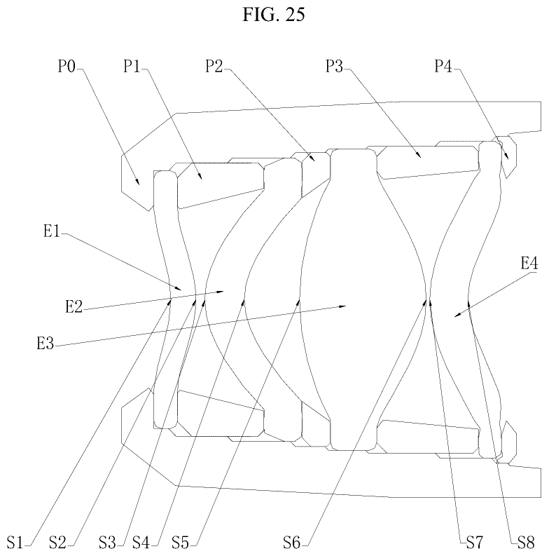

As shown in FIG. 25, an optical imaging lens assembly according to Embodiment VIII of the disclosure is described. A difference between this embodiment and Embodiment VII lies in the different distances and thicknesses between spacing elements, lenses, lens barrels P0, and so on.

FIG. 25 is a schematic structural diagram of an optical imaging lens assembly according to Embodiment VIII. For the sake of brevity, a portion of the description similar to Embodiment VII will be omitted. In this embodiment, the thickness of the lens barrel is significantly increased, facilitating the stability of the optical imaging lens assembly.

To sum up, Embodiment I to Embodiment VIII respectively meet relationships shown in Table 10.

TABLE 10

| Conditional | embodiment | | | | | | | |
|---|---|---|---|---|---|---|---|---|
| expression | 1 | 2 | 3 | 4 | 5 | 6 | 7 | 8 |
| CP1/(CT1 + CT2) | 1.11 | 1.06 | 1.06 | 1.06 | 0.93 | 0.89 | 1.34 | 1.34 |
| EP01/\|SAG11\| | 3.56 | 3.60 | 3.20 | 3.21 | 3.78 | 3.78 | 3.30 | 3.30 |
| D1s/(R1*N1) | −1.81 | −1.49 | −1.75 | −1.62 | −1.68 | −1.72 | −1.73 | −1.64 |
| D1m/R4 | 4.22 | 3.89 | 4.29 | 3.97 | 4.20 | 4.28 | 4.21 | 4.13 |
| D2m/R5 | 1.41 | 1.25 | 1.20 | 1.14 | 1.53 | 1.47 | 1.26 | 1.24 |
| R5*N3/d3s | 1.19 | 1.20 | 1.45 | 1.48 | 1.27 | 1.27 | 1.37 | 1.37 |
| D3m/R7/(D3s/R6) | −1.07 | −0.98 | −1.10 | −1.10 | −1.05 | −1.06 | −1.09 | −1.22 |
| f4/(CP3 + CT4) | −4.35 | −4.43 | −5.52 | −5.51 | −6.41 | −6.58 | −5.70 | −5.77 |
| L/CT3 | 3.03 | 3.07 | 3.23 | 3.37 | 2.72 | 2.72 | 3.31 | 3.31 |
| (D0m − D0s)/ImgH | 1.17 | 1.07 | 1.16 | 0.48 | 0.98 | 0.98 | 1.10 | 0.32 |
| (d0m − d0s)/ImgH | 1.01 | 1.16 | 1.30 | 1.19 | 1.17 | 1.17 | 1.23 | 1.23 |
| f4/T34 | −105.74 | −105.74 | −153.15 | −153.15 | −165.55 | −165.55 | −231.04 | −231.04 |
| R7/d3m | 0.46 | 0.44 | 0.42 | 0.42 | 0.45 | 0.46 | 0.41 | 0.42 |

Table 11 shows effective focal lengths f1 to f4 of lenses of the optical imaging lens assembly in Embodiment I to Embodiment VIII, as well as a vector height SAG11 of the object-side surface of the first lens.

TABLE 11

| | embodiment | | | | | | | |
|---|---|---|---|---|---|---|---|---|
| Parameter | 1 | 2 | 3 | 4 | 5 | 6 | 7 | 8 |
| f1(mm) | −171.23 | −171.23 | 107.00 | 107.00 | 75.62 | 75.62 | 166.44 | 166.44 |
| f2(mm) | 72.71 | 72.71 | 195.91 | 195.91 | −82.52 | −82.52 | 216.25 | 216.25 |
| f3(mm) | 6.64 | 6.64 | 6.82 | 6.82 | 6.67 | 6.67 | 6.75 | 6.75 |
| f4(mm) | −23.47 | −23.47 | −30.48 | −30.48 | −32.59 | −32.59 | −32.00 | −32.00 |
| SAG11(mm) | −0.61 | −0.61 | −0.72 | −0.72 | −0.69 | −0.69 | −0.68 | −0.68 |

Table 12 provides partial structural parameters of the optical imaging lens assembly in Embodiment I to Embodiment VIII.

TABLE 12

| | embodiment | | | | | | | |
|---|---|---|---|---|---|---|---|---|
| Parameter | 1 | 2 | 3 | 4 | 5 | 6 | 7 | 8 |
| D1s | 10.400 | 8.563 | 10.200 | 9.400 | 10.000 | 10.200 | 10.096 | 9.557 |
| D1m | 10.800 | 9.958 | 10.600 | 9.800 | 10.400 | 10.600 | 10.439 | 10.243 |
| D2m | 11.600 | 10.253 | 11.400 | 10.800 | 11.600 | 11.140 | 11.396 | 11.196 |
| d3s | 10.521 | 10.358 | 9.983 | 9.776 | 9.070 | 9.070 | 10.044 | 10.044 |
| D3s | 11.800 | 11.392 | 11.600 | 11.000 | 11.000 | 11.161 | 11.413 | 10.196 |
| D3m | 12.200 | 10.862 | 12.000 | 11.400 | 11.400 | 11.641 | 11.796 | 11.796 |
| d0s | 9.398 | 8.385 | 8.197 | 8.194 | 8.339 | 8.339 | 8.461 | 8.462 |
| d0m | 13.316 | 12.886 | 13.220 | 12.801 | 12.878 | 12.878 | 13.211 | 13.211 |
| D0s | 11.043 | 11.012 | 10.858 | 12.572 | 11.809 | 11.809 | 11.234 | 11.234 |
| D0m | 15.552 | 15.162 | 15.341 | 14.438 | 15.609 | 15.609 | 15.491 | 12.491 |
| EP01 | 2.162 | 2.186 | 2.316 | 2.321 | 2.589 | 2.589 | 2.228 | 2.228 |
| CP1 | 2.879 | 2.750 | 3.106 | 3.119 | 2.888 | 2.788 | 3.427 | 3.427 |
| CP3 | 3.852 | 3.749 | 4.093 | 4.108 | 3.546 | 3.416 | 4.101 | 4.036 |
| L | 15.811 | 15.983 | 15.896 | 16.596 | 16.233 | 16.233 | 16.673 | 16.673 |
| d3m | 9.40 | 9.94 | 10.17 | 10.18 | 9.79 | 9.75 | 10.39 | 10.12 |

In an embodiment of the disclosure, an imaging device is provided. An electronic photosensitive element of the imaging device may be a Charge-Coupled Device (CCD) or a Complementary Metal Oxide Semiconductor (CMOS). The imaging device may be an independent imaging device such as a digital camera, and may also be an imaging module which is integrated on a mobile electronic device such as a mobile phone. The imaging device is provided with the optical imaging lens assembly described above.

It is apparent that the described embodiments are only part of the embodiments of the disclosure, not all the embodiments. Based on the embodiments in the disclosure, all other embodiments obtained by those of ordinary skill in the art without creative work shall fall within the protection scope of the disclosure.

It is to be noted that, terms used herein are intended to describe specific implementations only and are not intended to limit exemplary embodiments according to the disclosure. As used herein, unless the context clearly indicates otherwise, a singular form is also intended to include a plural form. In addition, it is further understood that when the terms “including” and/or “comprising” are used in this specification, the terms indicate the presence of features, steps, operations, devices, components, and/or a combination thereof.

It is to be noted that terms “first”, “second” and the like in the description, claims and the above mentioned drawings of the disclosure are used for distinguishing similar objects rather than describing a specified sequence or a precedence order. It should be understood that the data used in such a way may be exchanged where appropriate, in order that the implementations of the disclosure described here may be implemented in an order other than those illustrated or described herein.

The above are only the preferred embodiments of the disclosure and are not intended to limit the disclosure. For those skilled in the art, the disclosure may have various modifications and variations. Any modifications, equivalent replacements, improvements and the like made within the spirit and principle of the disclosure all fall within the scope of protection of the disclosure.

What is claimed is:

1. An optical imaging lens assembly having four lenses having refractive powers, the optical imaging lens assembly comprising:
a lens assembly, wherein the lens assembly comprises, from an object side to an image side of the optical imaging lens assembly, a first lens to a fourth lens, which are sequentially arranged at intervals;
a spacing element assembly, wherein the spacing element assembly comprises at least a first spacing element that is located between the first lens and a second lens and is in at least partial contact with an image-side surface of the first lens, a second spacing element that is located between the second lens and a third lens and is in at least partial contact with an image-side surface of the second lens, and a third spacing element that is located between the third lens and the fourth lens and is in at least partial contact with an image-side surface of the third lens; and
a lens barrel, wherein the lens assembly and the spacing element assembly are accommodated in the lens barrel;
wherein an effective focal length f4 of the fourth lens and a distance T34 between the image-side surface of the third lens and an object-side surface of the fourth lens on the optical axis meet: −231.04≤f4/T34≤−105.74; and
the effective focal length f4 of the fourth lens, a center thickness CT4 of the fourth lens, and a maximum thickness CP3 of the third spacing element along the optical axis meet:
$$- 6.58 \leq f 4 / ( CP 3 + CT 4 ) \leq - 4.35 .$$

2. The optical imaging lens assembly according to claim 1, wherein a maximum thickness CP1 of the first spacing element along the optical axis, a center thickness CT1 of the first lens, and a center thickness CT2 of the second lens meet: 0.89≤CP1/(CT1+CT2)≤1.34.

3. The optical imaging lens assembly according to claim 1, wherein a distance EP01 between an object-side end surface of the lens barrel and an object-side surface of the first spacing element on the optical axis and a vector height SAG11 of an object-side surface of the first lens meet: 3.20≤EP01/|SAG11|≤3.78.

4. The optical imaging lens assembly according to claim 1, wherein the first lens is a glass aspheric lens, and an outer diameter D1s of an object-side surface of the first spacing element, a curvature radius R1 of an object-side surface of the first lens, and a refractive index N1 of the first lens meet: −1.81≤D1s/(R1*N1)≤−1.49.

5. The optical imaging lens assembly according to claim 1, wherein a curvature radius R4 of the image-side surface of the second lens and an outer diameter D1m of an image-side surface of the first spacing element meet: 3.89≤D1m/R4≤4.29.

6. The optical imaging lens assembly according to claim 1, wherein an outer diameter D2m of an image-side surface of the second spacing element and a curvature radius R5 of an object-side surface of the third lens meet: 1.14≤D2m/R5≤1.53.

7. The optical imaging lens assembly according to claim 1, wherein the third lens is a glass aspheric lens, and a curvature radius R5 of an object-side surface of the third lens, a refractive index N3 of the third lens, and an inner diameter d3s of an object-side surface of the third spacing element meet: 1.19≤R5*N3/d3s≤1.48.

8. The optical imaging lens assembly according to claim 1, wherein an outer diameter D3m of an image-side surface of the third spacing element, an outer diameter D3s of an object-side surface of the third spacing element, a curvature radius R6 of the image-side surface of the third lens, and a curvature radius R7 of the object-side surface of the fourth lens meet: −1.22≤D3m/R7/(D3s/R6)≤−0.98.

9. The optical imaging lens assembly according to claim 1, wherein a maximum height L of the lens barrel and a center thickness CT3 of the third lens meet: 2.72≤L/CT3≤3.37.

10. The optical imaging lens assembly according to claim 1, wherein an outer diameter Dom of an image-side end surface of the lens barrel, an outer diameter D0s of an object-side end surface of the lens barrel, and a half of a diagonal length ImgH of an effectively pixel region on an imaging surface of the optical imaging lens assembly meet: 0.32≤(D0m−D0s)/ImgH≤1.17.

11. The optical imaging lens assembly according to claim 1, wherein an inner diameter d0s of an object-side end surface of the lens barrel, an inner diameter d0m of an image-side end surface of the lens barrel, and a half of a diagonal length ImgH of an effectively pixel region on an imaging surface of the optical imaging lens assembly meet: 1.01≤(d0m−d0s)/ImgH≤1.30.

12. The optical imaging lens assembly according to claim 1, wherein the third lens has a positive refractive power, and the fourth lens has a negative refractive power.

13. The optical imaging lens assembly according to claim 1, wherein an object-side surface of the first lens is a concave surface, the image-side surface of the first lens is a convex surface, an object-side surface of the second lens is a convex surface, the image-side surface of the second lens is a concave surface, an object-side surface of the third lens is a convex surface, the image-side surface of the third lens is a convex surface, the object-side surface of the fourth lens is a convex surface, and an image-side surface of the fourth lens is a concave surface.
